(19) United States
(12) Patent Application Publication
(10) Pub. No.: US 2021/0295836 A1
(43) Pub. Date: Sep. 23, 2021

(54) INFORMATION PROCESSING APPARATUS, INFORMATION PROCESSING METHOD, AND PROGRAM

(71) Applicant: SONY CORPORATION, TOKYO (JP)

(72) Inventors: HIRO IWASE, TOKYO (JP); YUHEI TAKI, TOKYO (JP); KUNIHITO SAWAI, TOKYO (JP); MASAKI TAKASE, TOKYO (JP); AKIRA MIYASHITA, TOKYO (JP)

(21) Appl. No.: 17/250,436

(22) PCT Filed: Jul. 17, 2019
(86) PCT No.: PCT/JP2019/028009

§ 371 Date: Jan. 21, 2021

(30) Foreign Application Priority Data
Jul. 31, 2018 (JP) 2018-143252

(51) Int. Cl. G10L 15/22

(52) U.S. Cl. CPC G10L 15/22; G10L 2015/223

(57) ABSTRACT

The present technology relates to an information processing apparatus, an information processing method, and a program that can issue an execution instruction of a function using an instruction word associated with past memory. According to an aspect of the present technology, an information processing apparatus searches for, on the basis of an operation log in which a function executed in accordance with an operation performed by a user, and a context obtained when the operation is performed are recorded in association, the function recorded in association with the context indicating an instruction word input by the user, executes the retrieved function, and outputs a response to the user. The present technology can be applied to an agent device operable by voice.

### TECHNICAL FIELD

The present technology relates to an information processing apparatus, an information processing method, and a program, and particularly relates to an information processing apparatus, an information processing method, and a program that can issue an execution instruction of a function using an instruction word associated with past memory.

### BACKGROUND ART

A device equipped with an agent function that can perform a voice operation has become common. A user can execute various functions such as reproduction of music and sending of a message.

For example, the user can execute a reproduction function of music by uttering “play music of XX” while designating an artist name.

### CITATION LIST

### Patent Document

Patent Document 1: WO2016/151699 A
Patent Document 2: Japanese Unexamined Patent Application Publication No. 2017-516153

### SUMMARY OF THE INVENTION

### Problems to be Solved by the Invention

It is convenient to convert a plurality of functions including a creation function and a sending function of a message, and the like, into a macro and execute the macro, by a collective operation by utterance using an instruction word such as “send a usual message to XX”. Because the user needs not designate a macro to be executed, using a specific registered name, the user needs not memorize the name of each macro. This becomes more useful if the user uses a device for a relatively long time and the number of registered macros increases. Here, an instruction word in the utterance of “send a usual message to XX” is “usual”.

The present technology has been devised in view of such situations, and enables an execution instruction of a function to be issued using an instruction word associated with past memory.

### Solutions to Problems

According to an aspect of the present technology, an information processing apparatus includes a search unit configured to, on the basis of an operation log in which a function executed in accordance with an operation performed by a user, and a context obtained when the operation is performed are recorded in association, search for the function recorded in association with the context indicating an instruction word input by the user, and a response control unit configured to execute the retrieved function and output a response to the user.

According to an aspect of the present technology, on the basis of an operation log in which a function executed in accordance with an operation performed by a user, and a context obtained when the operation is performed are recorded in association, the function recorded in association with the context indicating an instruction word input by the user is searched for, the retrieved function is executed, and a response to the user is output.

### Effects of the Invention

According to the present technology, the user can issue an execution instruction of a function using an instruction word associated with past memory.

Note that the effect described here is not necessarily limited, and may be any effect described in the present disclosure.

### BRIEF DESCRIPTION OF DRAWINGS

FIG. 1 is a diagram illustrating a configuration example of an information processing system according to an embodiment of the present technology.

FIG. 2 is a diagram illustrating an example of a record of a user operation log.

FIG. 3 is a diagram illustrating an example of execution of a macro.

FIG. 4 is a diagram illustrating another configuration example of an information processing system.

FIG. 5 is a block diagram illustrating a hardware configuration example of an information processing terminal.

FIG. 6 is a block diagram illustrating a hardware configuration example of an information processing server.

FIG. 7 is a block diagram illustrating a functional configuration example of an information processing system.

FIG. 8 is a diagram illustrating an example of NLU processing.

FIG. 9 is a block diagram illustrating a configuration example of an operation record search processing unit in FIG. 7.

FIG. 10 is a diagram illustrating an example of a structure of a user operation log.

FIG. 11 is a diagram illustrating an example of an observation context.

FIG. 12 is a diagram illustrating an example of a generation context.

FIG. 13 is a diagram illustrating an example of an agent.

FIG. 14 is a diagram illustrating a first example of a macro extraction template.

FIG. 15 is a diagram illustrating a second example of a macro extraction template.

FIG. 16 is a diagram illustrating a third example of a macro extraction template.

FIG. 17 is a diagram illustrating a search example of a function sequence.

FIG. 18 is a diagram illustrating an operation of an information processing system that is performed in a case where each utterance is performed.

FIG. 19 is another diagram illustrating an operation of an information processing system in a case where each utterance is performed.

FIG. 20 is a flowchart illustrating response processing of an information processing server.

FIG. 21 is a flowchart illustrating operation record/search processing performed in Step S4 of FIG. 20.

FIG. 22 is a flowchart illustrating operation record/search processing performed in Step S4 of FIG. 20, following FIG. 21.

FIG. 23 is a diagram illustrating an example of a presentation screen of a macro.

### MODE FOR CARRYING OUT THE INVENTION

Hereinafter, a mode for carrying out the present technology will be described. The description will be given in the following order.

1. Voice Operation That Is Based on Episodic Memory

2. Configuration of Information Processing System

3. Operation of Information Processing System

4. Modified Example

### Voice Operation that is Based on Episodic Memory

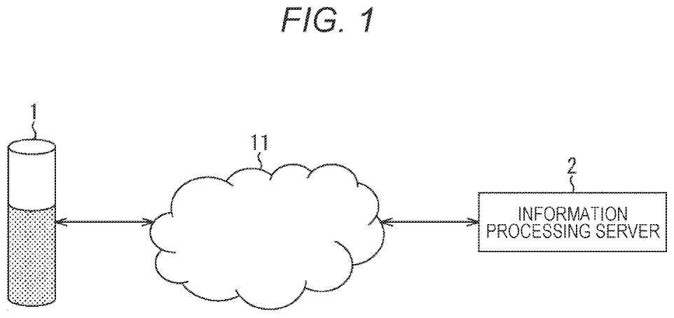

FIG. 1 is a diagram illustrating a configuration example of an information processing system according to an embodiment of the present technology.

An information processing system in FIG. 1 includes an information processing terminal 1 and an information processing server 2 that are connected via a network 11 such as the internet. By the information processing terminal 1 and the information processing server 2 performing processing in cooperation, a so-called agent function is implemented. A user can execute various functions such as reproduction of music and sending of a message by voice.

The information processing terminal 1 includes an input-output device such as a microphone, a camera, and a speaker. The information processing terminal 1 detects voice of the user by the microphone, and transmits voice data to the information processing server 2.

By analyzing the content of utterance, the information processing server 2 estimates intent of the user, and executes a function suitable for the intent of the user. The information processing server 2 transmits an execution result of the function to the information processing terminal 1, and causes the information processing terminal 1 to output the execution result as a response to the user.

In this manner, in the information processing system in FIG. 1, basically, the information processing terminal 1 functions as a user interface (UI) and the information processing server 2 executes a function suitable for the intent of the user. The agent function is thereby implemented.

In the information processing system, the user is enable to collectively execute, as a macro, a function sequence including a plurality of functions identical to functions executed in the past. Furthermore, the user is enabled to designate the execution of such a macro by utterance using an instruction word indicating a past event experienced by itself.

In the information processing system, a history of an operation of the user is managed as a user operation log. The generation of a macro is performed on the basis of information recorded in a user operation log.

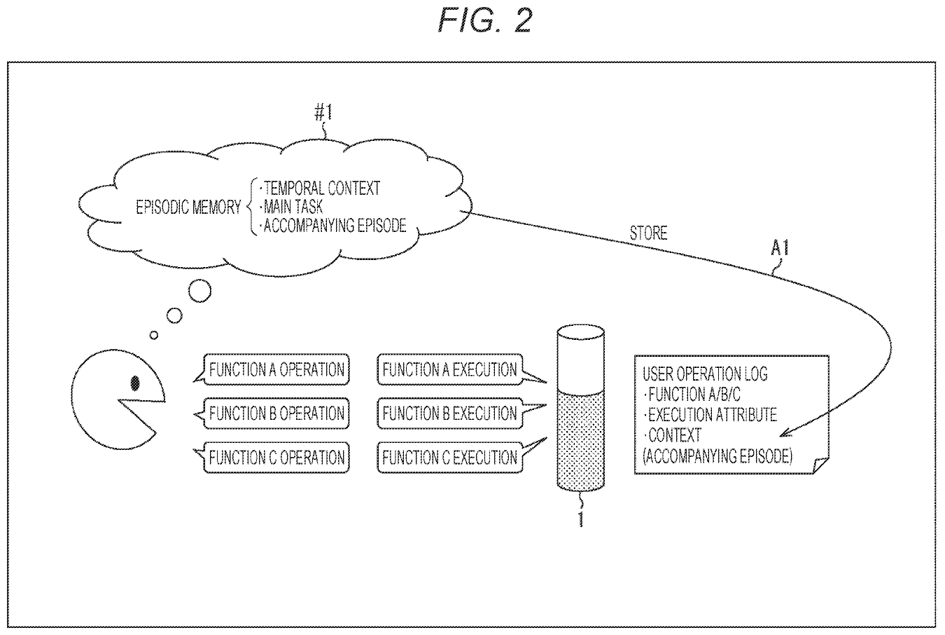

FIG. 2 is a diagram illustrating an example of a record of a user operation log.

As illustrated in a speech balloon on the left side in FIG. 2, it is assumed that the user sequentially performs operations for executing a function A, a function B, and a function C, by performing predetermined utterance. Predetermined processing is performed in the information processing server 2 in accordance with the user utterance, and an execution result of the function A, an execution result of the function B, and an execution result of the function C are output from the information processing terminal 1.

Here, the user memorizes an event in which the operations for executing the function A, the function B, and the function C have been performed, as episodic memory together with accompanying information indicating when, where, in what situation the event has been experienced, and the like. The episodic memory is a structure of memory for memorizing the content of the event together with accompanying information obtained when the event is experienced. Situations as the accompanying information include a task (main task) being performed by the user, mood of a surrounding environment, actions and feeling of the user and nearby people, and the like.

A temporal context indicated in a speech balloon #1 indicates temporal memory obtained when the operations for executing the function A, the function B, and the function C have been performed. A main task indicates memory related to content of a task being performed in the operations for executing the function A, the function B, and the function C. An accompanying episode indicates another pieces of accompanying information obtained when the operations for executing the function A, the function B, and the function C have been performed.

In the information processing system, as described above, a user operation log being a history of an operation of the user is managed. In a user operation log generated when the operations for executing the function A, the function B, and the function C have been performed, information indicating the function A, the function B, and the function C, and information indicating an execution attribute are recorded as indicated in a portion pointed by an arrow A1. The execution attribute is an attribute such as a value used in the execution of a function.

Furthermore, information indicating a context estimated to be memorized by the user as accompanying information of an episodic memory together with the event in which the operations for executing the function A, the function B, and the function C have been performed is recorded in the user operation log.

The context includes a situation of the time when an operation has been performed, such as time and date on which an operation has been performed, and a location where an operation has been performed. Situations as the context also include a task being performed by the user, mood of a surrounding environment, actions and feeling of the user and nearby people, and the like. At least any of time and date, a location, a task being performed by the user, mood of a surrounding environment, and actions and feeling of the user and nearby people is recorded as a context.

For example, the context is observed by analyzing an image captured by the camera of the information processing terminal 1, or sensor data detected by a sensor of the information processing terminal 1, and is recorded in the user operation log.

As described in detail later, not an observed context but a context generated on an information processing system side is appropriately recorded in the user operation log. An event or the like that is estimated to be memorized by the user as accompanying information of episodic memory is generated on the information processing system side and presented to the user, and information regarding the content of the event is recorded in the user operation log as a context.

In this manner, in the information processing system, a function sequence including a plurality of functions, and a context obtained when operations for executing these functions have been performed are managed in association. A function sequence associated with a context is executed as one macro.

Note that, in FIG. 2, an operation of the information processing terminal 1 is performed by voice, but the operation may be performed by another operation such as an operation performed using a controller or a touch operation.

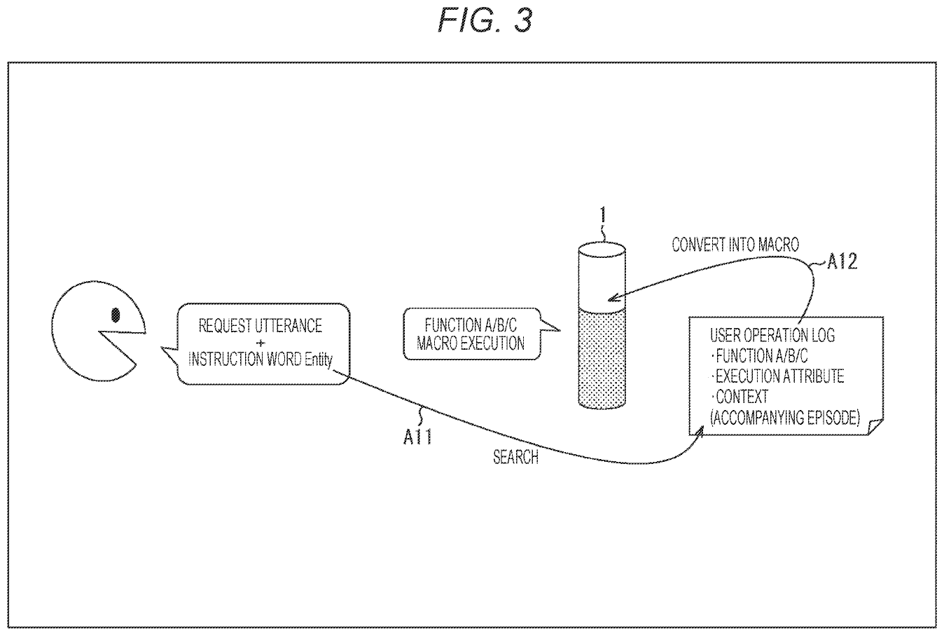

FIG. 3 is a diagram illustrating an example of execution of a macro.

It is assumed that the user considers that the user desires to execute the function A, the function B, and the function C that have been executed in the past, again after a predetermined time elapses from when a user operation log is generated.

As indicated in a speech balloon on the left side of FIG. 3, the user performs utterance of content requesting the execution of the function A, the function B, and the function C, in the form of including an instruction word Entity. The purpose of the utterance is execution of the function A, the function B, and the function C. The instruction word Entity is a word indicating a function to be executed, among functions executed in the past, on the basis of accompanying information of episodic memory.

In the information processing system, the user operation log is searched for a function sequence with content matching the purpose of the user utterance. Here, a function sequence including the function A, the function B, and the function C is searched for.

Furthermore, as indicated by an arrow A11, a function sequence recorded in association with context indicated by an instruction word Entity is selected from among function sequences obtained as a search result, and the function A, the function B, and the function C included in the selected function sequence are collectively executed as a macro.

For example, in a case where operations for executing the function A, the function B, and the function C are performed in a living room of a home of the user, the function sequence of the function A, the function B, and the function C, and an execution attribute are recorded in a user operation log. Information indicating that a location where an operation has been performed is a living room is recorded in the function sequence in association as a context.

On the other hand, the user memorizes that the user has performed the operations for executing the function A, the function B, and the function C in the living room. For example, the function A, the function B, and the function C are assumed to be a series of functions regarding the sending of a message including a creation function of a message and a sending function of a message.

In this state, in a case where the use utters “a message that I previously sent in the living room”, on the basis of episodic memory of itself, from among function sequences including the function A, the function B, and the function C, a function sequence associated with information indicating that a location where an operation has been performed is a living room, as a context is retrieved. Furthermore, the function A, the function B, and the function C are collectively executed using an execution attribute of the retrieved function sequence. An instruction word Entity that is based on episodic memory is a living room.

In this manner, the information processing system in FIG. 1 is a system that can memorize accompanying information of an event as episodic memory, and collectively execute the same operations as operations executed in the past, by natural utterance utilizing the characteristic of human memory of remembering.

Even in a case where the user does not remember the details of content of operations executed in the past, such as content managed as an execution attribute, by performing utterance indicating a situation or the like that is memorized as accompanying information, the user can easily perform the same operation as a past operation.

The above-described operation using voice is performed while the user is performing an action such as a game, as a main task, for example. The user operation log managed by the information processing system includes, as a context, information indicating a situation of a game as a main task. The information processing server 2 can check a situation or the like of a game being played by the user.

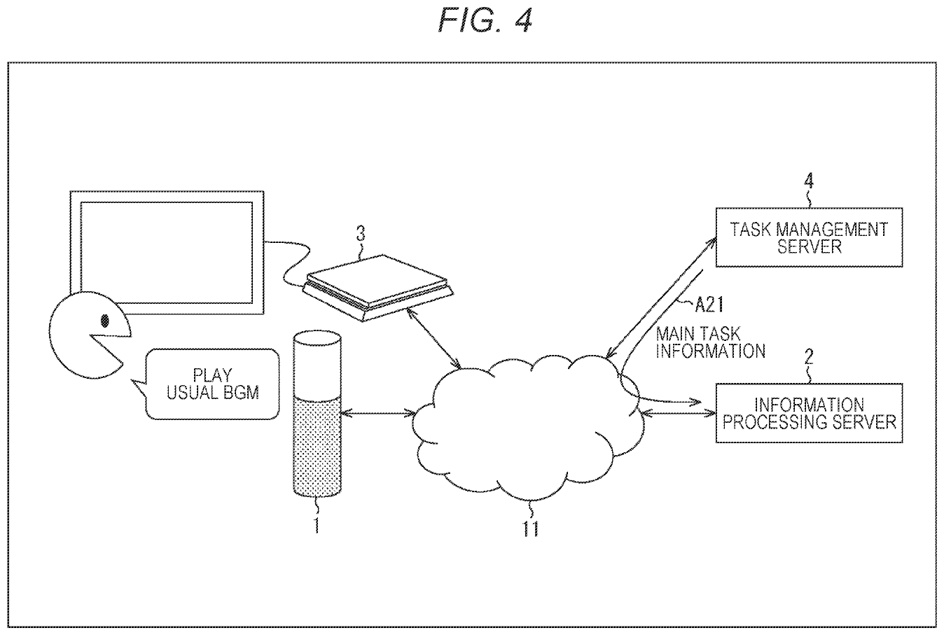

FIG. 4 is a diagram illustrating another configuration example of an information processing system.

In the example illustrated in FIG. 4, a game machine 3 being a stationary game machine is installed in a living room or the like of a home of the user where the information processing terminal 1 is placed. By performing utterance toward the information processing terminal 1 while playing a game using the game machine 3, the user can use an agent function such as hearing of BGM.

The game machine 3 is connected to the network 11 via a router or the like that is provided at the home, similarly to the information processing terminal 1. The game machine 3 communicates with a task management server 4 via the network 11, and downloads a program of a game from the task management server 4, and transmits information regarding an operation of a game that is performed by the user, to the task management server 4.

The task management server 4 manages information regarding a game performed by the user using the game machine 3. The information managed by the task management server 4 is appropriately provided to the information processing server 2 as information regarding a main task of the user as indicated by an arrow A21.

In the information processing server 2, a situation or the like of the main task of the user is checked on the basis of information transmitted from the task management server 4. In a case where the user is performing a game, the information processing server 2 performs processing of requesting the task management server 4 to generate a predetermined event such as appearance of a specific character or acquisition of a specific item in the game, and the like.

In the task management server 4, a communication service that uses a virtual space (VR space/AR space) or the like is appropriately managed. By operating the game machine 3 or operating a smartphone (not illustrated), the user can access a virtual space managed by the task management server 4, and communicate with another user on the virtual space.

In this case, information regarding an action of the user on the virtual space, information regarding a location of the user on the virtual space, information regarding a scene of the virtual space, and the like are provided from the task management server 4 to the information processing server 2 as information regarding a main task of the user.

The details of the processing of the task management server 4 that manages a user operation log and executes a function in accordance with user utterance in the above-described manner will described later. The function of the task management server 4 that manages a main task of the user may be provided in the information processing server 2.

### Configuration of Information Processing System

### Configuration Example of Information Processing Terminal

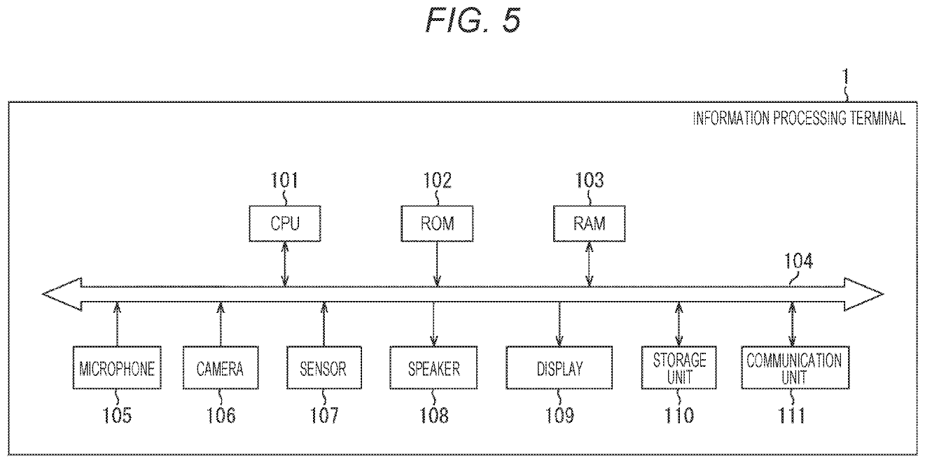

FIG. 5 is a block diagram illustrating a hardware configuration example of the information processing terminal 1.

A central processing unit (CPU) 101, a read only memory (ROM) 102, and a random access memory (RAM) 103 are connected to one another via a bus 104.

A microphone 105, a camera 106, sensor 107, a speaker 108, a display 109, a storage unit 110, and a communication unit 111 are connected to the bus 104.

The microphone 105 detects various types of sound such as voice of the user and environmental sound.

The camera 106 captures an image of a surrounding of the information processing terminal 1 that includes the user.

The sensor 107 includes various sensors such as an illuminance sensor that detects brightness of the surrounding, a distance measurement sensor that measures a distance to an object existing in the periphery, and a positioning sensor that uses a global positioning system (GPS).

The speaker 108 makes a response to an operation of the user by outputting synthesized voice in accordance with control performed by the information processing server 2, for example, and presents various types of information. For example, music reproduced by the information processing server 2 and the like are also output from the speaker 108.

The display 109 includes a display such as an LCD or an organic EL display. Various types of information are presented on the display 109 in accordance with control performed by the information processing server 2, for example.

In this manner, information presentation to the user may be performed by displaying a screen. Information presentation to the user may be performed using an external display connected via wireless communication, instead of being performed using the display 109 provided in the information processing terminal 1.

The storage unit 110 includes a nonvolatile memory or the like. The storage unit 110 stores various types of data such as programs to be executed by the CPU 101.

The communication unit 111 performs transmission and reception of various types of information with an external apparatus such as the information processing server 2 and the game machine 3 via wireless or wired communication. The communication unit 111 transmits data of voice detected by the microphone 105, image data obtained by the camera 106, and sensor data detected by the sensor 107, to the information processing server 2.

Furthermore, the communication unit 111 receives voice data transmitted from the information processing server 2, outputs the voice data to the speaker 108, and causes the speaker 108 to output synthesized voice. The communication unit 111 receives voice data transmitted from the information processing server 2, outputs the voice data to the display 109, and causes the display 109 to display various types of information such as an image and a text.

### Configuration Example of Information Processing Server

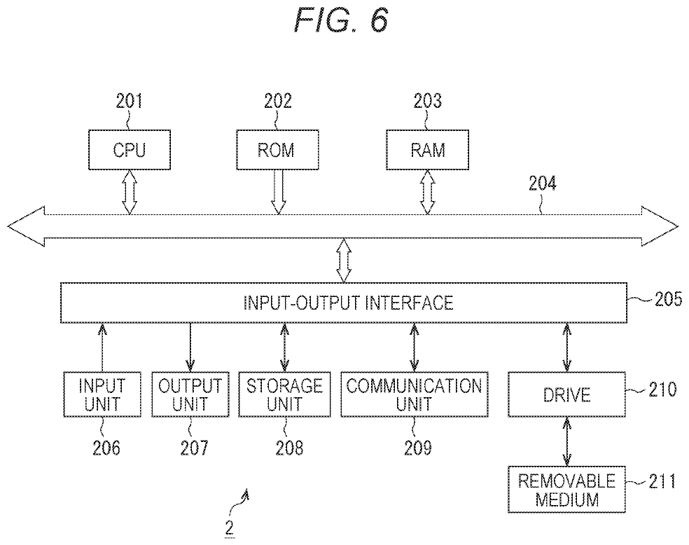

FIG. 6 is a block diagram illustrating a hardware configuration example of the information processing server 2.

A CPU 201, a ROM 202, and a RAM 203 are connected to one another via a bus 204.

An input-output interface 205 is further connected to the bus 204. An input unit 206 including a keyboard, a mouse, and the like, and an output unit 207 including a display, a speaker, and the like are connected to the input-output interface 205.

Furthermore, a storage unit 208 including a hard disc, a nonvolatile memory, and the like, a communication unit 209 including a network interface and the like, and a drive 210 that drives a removable medium 211 are connected to the input-output interface 205.

The information processing server 2 includes a computer having such a configuration. The information processing server 2 may include a plurality of computers instead of a single computer.

### Functional Configuration Example of Information Processing System

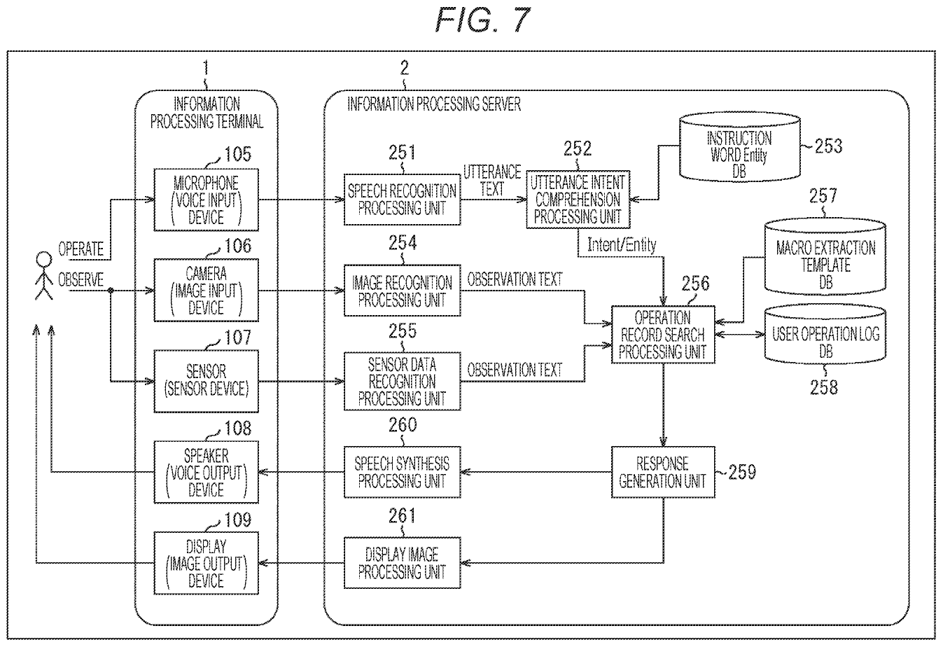

FIG. 7 is a block diagram illustrating a functional configuration example of an information processing system including the information processing terminal 1 and the information processing server 2 that have the above-described configuration.

As illustrated on the right side of FIG. 7, in the information processing server 2, a speech recognition processing unit 251, an utterance intent comprehension processing unit 252, an instruction word Entity DB 253, an image recognition processing unit 254, and a sensor data recognition processing unit 255 are implemented.

Furthermore, the information processing server 2 includes an operation record search processing unit 256, a macro extraction template DB 257, a user operation log DB 258, a response generation unit 259, a speech synthesis processing unit 260, and a display image processing unit 261. At least part of the functional units is implemented by a predetermined program being executed by the CPU 201 in FIG. 6.

Voice data detected by the microphone 105 serving as a voice input device, and transmitted from the information processing terminal 1 is received by the communication unit 209 and input to the speech recognition processing unit 251. Image data obtained by the camera 106 serving as an image input device, and transmitted from the information processing terminal 1 is received by the communication unit 209 and input to the image recognition processing unit 254. Sensor data detected by the sensor 107 serving as a sensor device, and transmitted from the information processing terminal 1 is received by the communication unit 209 and input to the sensor data recognition processing unit 255.

The speech recognition processing unit 251 performs speech recognition (automatic speech recognition (ASR)) processing on user utterance, and converts the user utterance into text data. The speech recognition processing unit 251 outputs an utterance text being text data indicating the content of the user utterance, to the utterance intent comprehension processing unit 252.

By performing utterance intent understanding (natural language understanding (NLU)) processing on the utterance text, the utterance intent comprehension processing unit 252 estimates Intent indicating the intent of utterance, and extracts Entity serving as a meaningful element included in the utterance.

Intent of user utterance intends the execution of a predetermined function, for example. Furthermore, Entity included in the user utterance is attribute information to be used for the execution of a function. The Entity extracted by the utterance intent comprehension processing unit 252 includes an Entity type indicating the type of Entity, and an Entity literal being a character string or a numerical value included in Entity.

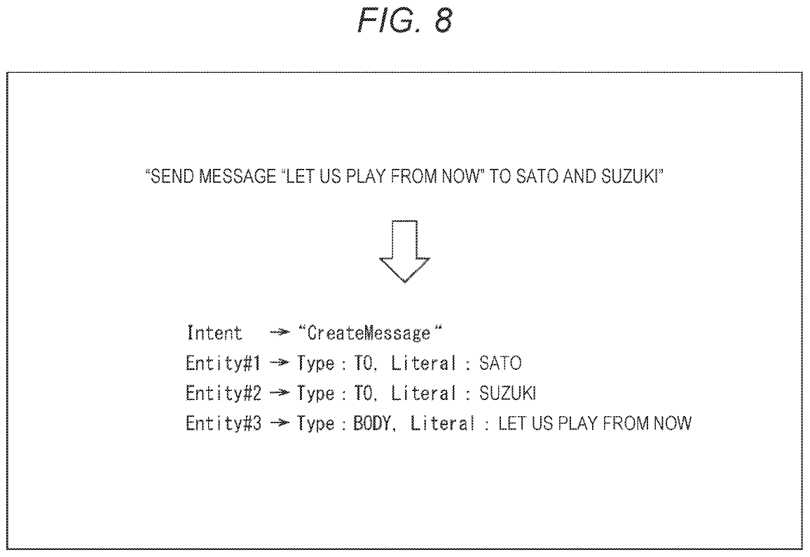

FIG. 8 is a diagram illustrating an example of NLU processing.

As illustrated in an upper part of FIG. 8, it is assumed that the user utters “send a message “let us play from now” to Sato and Suzuki”.

In this case, as illustrated in a portion pointed by a down-pointing arrow, “CreateMessage” is estimated as Intent. “CreateMessage” indicates the execution of a creation function of a message.

Furthermore, three Entities including Entities #1 to #3 are estimated as Entity.

Entity #1 is Entity having “TO” as Entity type and “Sato” as Entity literal. Entity #2 is Entity having “TO” as Entity type and “Suzuki” as Entity literal. Entity type of “TO” indicates that a corresponding Entity is Entity indicating a send destination of a message.

Entity #3 is Entity having “BODY” as Entity type and “let us play from now” as Entity literal. Entity type of “BODY” indicates that a corresponding Entity is Entity indicating a body of a message.

In this manner, an operation of the user is represented as a set of Intent and Entity. The utterance intent comprehension processing unit 252 in FIG. 7 outputs Intent and Entity obtained by NLU processing, to the operation record search processing unit 256.

Note that, here, processing performed in a case where the user performs an operation by voice is described, but as described above, a user operation is performed by another operation such as an operation that uses a controller and a touch operation.

In a case where an operation is performed by an operation other than voice, information indicating the content of the user operation is converted into data having the same format as Intent/Entity obtained as a result of NLU processing. Intent/Entity corresponding to the operation other than voice is supplied to the operation record search processing unit 256.

Furthermore, in a case where an instruction word Entity is included in the utterance text, the utterance intent comprehension processing unit 252 extracts the instruction word Entity included in the utterance text. The extraction of the instruction word Entity that is performed by the utterance intent comprehension processing unit 252 is performed with reference to information stored in the instruction word Entity DB 253.

Generally, NLU processing is performed in such a manner that a phrase of each Entity type and a plurality of sentence examples including Entity for each Intent are pre-registered, and Intent is estimated on the basis of registered information, and Entity included in an utterance text is extracted.

For example, NLU processing on an utterance text “play XX (music title)” is performed in such a manner that Intent of “PlayMisic” is estimated on the basis of registered sentence examples, and Entity with Entity type “music title” is extracted on the basis of registered music titles.

The extraction of instruction word Entity to be used for the search of a function sequence, which will be described later, is performed in accordance with a structure similar to this structure. More specifically, instruction word Entity and a plurality of sentence examples including instruction word Entity for each Intent are registered, and estimation of Intent and extraction of instruction word Entity included in an utterance text are performed on the basis of the registered information.

For example, NLU processing on “play music of yesterday” is performed in such a manner that Intent of “PlayMisic” is estimated on the basis of registered sentence examples, and instruction word Entity “yesterday” is extracted on the basis of registered instruction word Entity. The Intent estimated in this manner and the instruction word Entity extracted from the utterance text are also supplied to the operation record search processing unit 256.

The image recognition processing unit 254 analyzes an image captured by the camera 106, and recognizes the situation of the user at the time of utterance, and the situation of a surrounding environment such as mood. A recognition result obtained by the image recognition processing unit 254 is output to the operation record search processing unit 256 as an observation context.

The sensor data recognition processing unit 255 analyzes sensor data detected by the sensor 107, and recognizes the situation of the user at the time of utterance, and the situation of a surrounding environment such as mood. A recognition result obtained by the sensor data recognition processing unit 255 is output to the operation record search processing unit 256 as an observation context.

The situation or the like of the user at the time of utterance ay be recognized on the basis of voice and environmental sound detected by the microphone 105.

The operation record search processing unit 256 manages the history of operations of the user on the basis of Intent/Entity supplied from the utterance intent comprehension processing unit 252, and an observation context supplied from the image recognition processing unit 254 or the sensor data recognition processing unit 255.

The operation record search processing unit 256 generates a function sequence including a plurality of functions, by clustering Intent/Entity supplied from the utterance intent comprehension processing unit 252, which will be described in detail later. The operation record search processing unit 256 records (writes), into a user operation log stored in the user operation log DB 258, a function sequence and a context obtained when an operation for executing a plurality of functions is performed, in association.

Furthermore, the operation record search processing unit 256 searches function sequences recorded in the user operation log, for a function sequence intended by the user, on the basis of instruction word Entity included in user utterance. For the search of a function sequence, a macro extraction template stored in the macro extraction template DB 257 is also used. The operation record search processing unit 256 extracts a plurality of functions included in the retrieved function sequence, as a macro, and causes the response generation unit 259 to execute the macro.

The response generation unit 259 collectively executes, as a macro, a plurality of functions included in the function sequence in accordance with control performed by the operation record search processing unit 256.

In a case where the response generation unit 259 presents an execution result of the macro to the user by voice, the response generation unit 259 outputs the execution result of the macro to the speech synthesis processing unit 260. Furthermore, in a case where the response generation unit 259 presents an execution result of the macro to the user by screen display, the response generation unit 259 outputs the execution result of the macro to the display image processing unit 261.

Aside from information presentation that uses voice or screen display, the response generation unit 259 performs various type of processing such as sending of a message, as a response to a user operation.

The speech synthesis processing unit 260 generates synthesized voice serving as a response to user utterance, in accordance with control performed by the response generation unit 259, and transmits data of the synthesized voice to the information processing terminal 1. In the information processing terminal 1, the data of synthesized voice transmitted from the information processing server 2 is received, and the synthesized voice is output from the speaker 108 serving as a voice output device.

The display image processing unit 261 generates an image serving as a response to user utterance, on the basis of information supplied from the response generation unit 259, and transmits image data to the information processing terminal 1. In the information processing terminal 1, the image data transmitted from the information processing server 2 is received, and the image is displayed on the display 109 serving as an image output device.

### Detailed Configuration of Operation Record Search Processing Unit

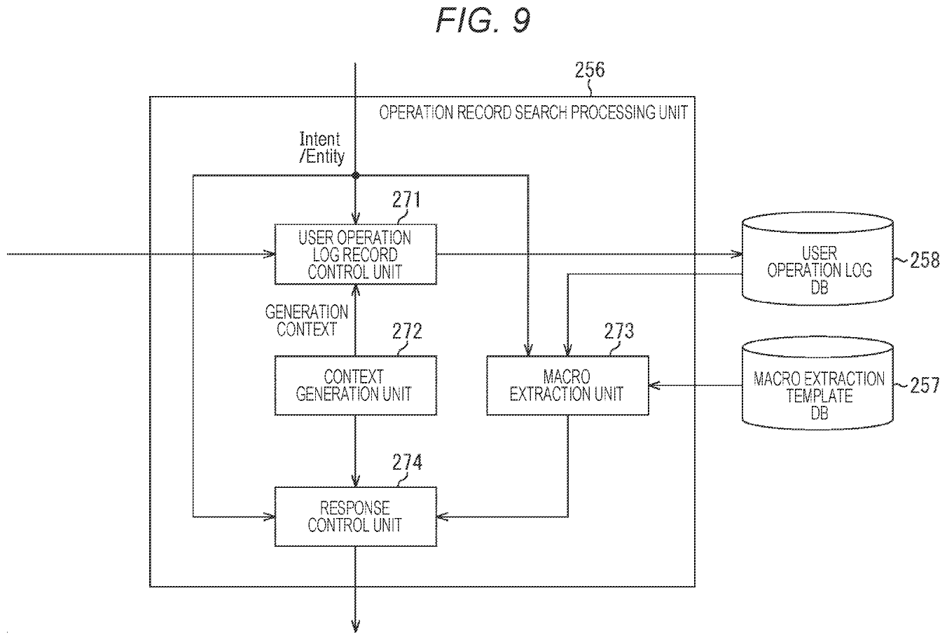

FIG. 9 is a block diagram illustrating a configuration example of the operation record search processing unit 256.

As illustrated in FIG. 9, the operation record search processing unit 256 includes a user operation log record control unit 271, a context generation unit 272, a macro extraction unit 273, and a response control unit 274. Intent/Entity output from the utterance intent comprehension processing unit 252 is input to the user operation log record control unit 271, the macro extraction unit 273, and the response control unit 274. Furthermore, an observation context output from the image recognition processing unit 254 or the sensor data recognition processing unit 255 is input to the user operation log record control unit 271.

Recording of User Operation Log

The user operation log record control unit 271 generates a cluster including a function sequence including a plurality of functions, by clustering functions indicated by Intent/Entity supplied from the utterance intent comprehension processing unit 252.

The function sequence is generated in accordance with a plurality of operations as one group being performed by the user. The function sequence is information regarding a combined operation obtained by combining a plurality of operations. Clustering is performed as follows, for example.

(1) Clustering that is Based on Time Between Utterances

An operation performed by utterance performed within a predetermined time such as five seconds, for example, from the last utterance is recorded as an operation included in the same cluster as an operation performed by the last utterance. In a case where an observation context changes within the time of the same cluster, the changed observation context is recorded as a context of the cluster.

(2) Clustering that is Based on Coidentity of Context

In a case where an operation performed by utterance performed within a predetermined time such as three minutes, for example, from the last utterance is performed with the same context as the operation performed by the last utterance, these operations are recorded as operations included in the same cluster.

(3) Clustering that is Based on Closeness in Linguistic Semantic Concept

In a case where an operation performed by utterance performed within a predetermined time such as three minutes, for example, from the last utterance is an operation semantically similar to the operation performed by the last utterance, these operations are recorded as operations included in the same cluster.

(4) Recording of UnDo Operation

In a case where a cancellation instruction of a specific operation is issued, the specific operation for which the cancellation instruction has been issued may be prevented from being included as an operation included in a cluster.

For example, in a case where an operation with Intent=“StopMusic” (music reproduction stop operation) is performed within five seconds from when an operation with Intent=“PlayMusic”, Entity=“A[TARGET_MUSIC]” (music reproduction operation of A) is performed, information regarding these operations is deleted from a cluster. It is considered that the music stopped immediately before the operation is not music the user desired to hear. This can prevent a function unintended by the user, from being included in a macro and executed.

The user operation log record control unit 271 records, into a user operation log, information regarding the function sequence generated by clustering, and information regarding a context obtained when an operation for executing a plurality of functions included in the function sequence has been performed.

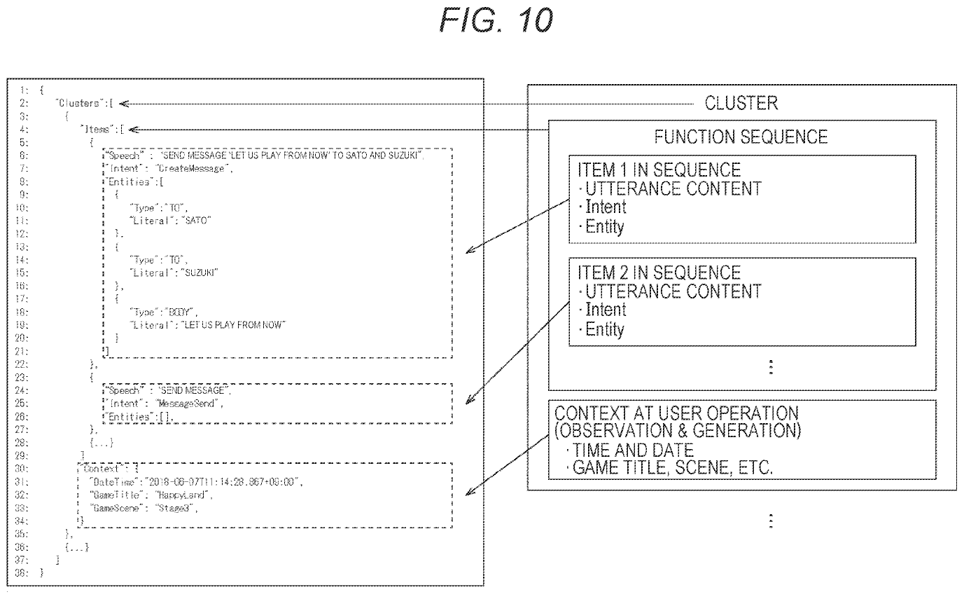

FIG. 10 is a diagram illustrating an example of a structure of a user operation log.

As illustrated on the left side in FIG. 10, a user operation log is generated as information in a Java Script (registered trademark) Object Notation (JSON) format, for example. A number and colon (:) at the beginning of each description in the user operation log illustrated in FIG. 10 are added for the sake of explanatory convenience, and are not description included in the user operation log.

The entire description on the first to 38th rows serves as description of one user operation log. As illustrated on the second row, information regarding each cluster generated by clustering is described in the user operation log.

Items on the fourth to 29th rows serve as description of a function sequence included in a cluster. The function sequence includes, as an item (item in a sequence), information regarding each function included in the function sequence. As information regarding each function, Speech being an utterance text, Intent, and Entity are described.

The description on sixth to 21st rows serves as description about a first function included in the function sequence. The first function is the same operation as the function described with reference to FIG. 8.

More specifically, as illustrated on the sixth row, “send a message “let us play from now” to Sato and Suzuki” is described as Speech. Furthermore, as illustrated on the seventh row, “CreateMessage” is described as Intent.

As illustrated on the tenth and 11th rows, Entity type “TO” and Entity literal “Sato” are described as first Entity. As illustrated on the 14th and 15th rows, Entity type “TO” and Entity literal “Suzuki” are described as second Entity. As illustrated on the 18th and 19th rows, Entity type “BODY” and Entity literal “let us play from now” are described as third Entity.

The description on 24th to 26th rows serves as description about a second function included in the function sequence.

As illustrated on the 24th row, “send a message” is described as Speech. Furthermore, as illustrated on the 25th row, “MessageSend” is described as Intent. “MessageSend” indicates the execution of a sending function of a message. Note that an operation of “MessageSend” does not include Entity.

Information regarding the functions included in the function sequence is sequentially described in this manner.

Context on 30th and 34th rows serves as description of a context obtained when an operation for executing a function is performed.

DateTime on 31st row indicates time and date of an operation. In the example illustrated in FIG. 10, DateTime indicates “2018-06-07T11:14:28.867+09:00”.

GameTitle on 32nd row indicates a title of a game being played by the user as a main task. In the example illustrated in FIG. 10, GameTitle indicates “HappyLand”.

GameScene on 33rd row indicates a scene of a game being played by the user as a main task. In the example illustrated in FIG. 10, GameScene indicates “Stage3”.

As described above, the user can operate an agent function while playing a game as a main task. GameTitle and GameScene are described on the basis of information acquired from the task management server 4, for example.

Information regarding the main task that has been acquired from the task management server 4, and the like are also appropriately supplied to the user operation log record control unit 271 as an observation context, and described in the user operation log.

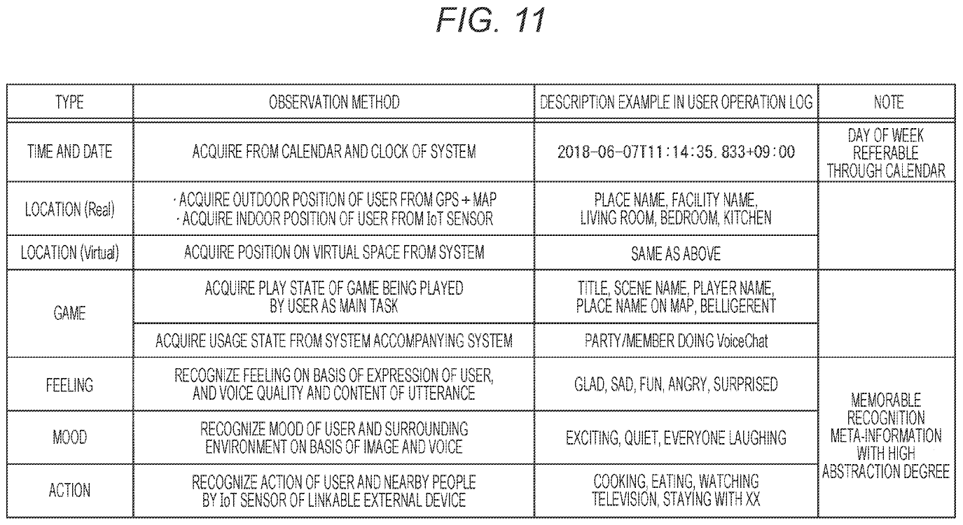

FIG. 11 is a diagram illustrating an example of an observation context.

As illustrated the left column in FIG. 11, the type of an observation context includes, time and date, location (Real), location (Virtual), game, feeling, mood, and action.

An observation context of time and date indicates time and date of an operation.

An observation context of time and date is described on the basis of information acquired from a calendar and a clock managed by the information processing server 2, for example. DateTime in FIG. 10 serves as an observation context of time and date.

An observation context of location (Real) indicates a real position of the user at the time of an operation.

An observation context of location (Real) is described on the basis of outdoor position information of the user measured by the GPS sensor and a map. The GPS sensor is mounted on a terminal such as the information processing terminal 1 or a smartphone carried by the user. Furthermore, an observation context of location (Real) is described on the basis of an indoor position of the user detected by an IoT sensor.

An observation context of location (Virtual) indicates a position on a virtual space of the user at the time of an operation. For example, in a case where the user is performing a main task of communicating with another user on the virtual space, an observation context of location (Virtual) is described.

An observation context of location (Virtual) is described on the basis of the position of the user on the virtual space that is acquired from the task management server 4, for example. Information indicating the position on the virtual space is transmitted from the task management server 4 serving as a system that manages the virtual space.

An observation context of game indicates a state of a game of the user at the time of an operation. For example, in a case where the user is playing a game as a main task, an observation context of game is described.

An observation context of game is described on the basis of information acquired from the game machine 3, or on the basis of information acquired from a system that manages a game being played by the user, such as the task management server 4. GameTitle and GameScene in FIG. 10 serve as an observation context of game.

An observation context of feeling indicates feeling of the user at the time of an operation.

An observation context of feeling is described on the basis of an analysis result of the expression of the user that is based on an image captured by the camera 106, or an analysis result of voice quality of the user that is based on voice detected by the microphone 105. As an observation context of feeling, for example, information indicating “glad”, “sad”, “fun”, “angry”, or “surprised” is described.

An observation context of mood indicates the mood of the user or the mood of a surrounding environment at the time of an operation.

An observation context of mood is described on the basis of a recognition result of mood that is based on an image captured by the camera 106 or voice detected by the microphone 105. As an observation context of mood, for example, information indicating “exciting”, “quiet”, or “everyone laughing” is described.

An observation context of action indicates an action of the user or actions of nearby people at the time of an operation.

An observation context of action is described on the basis of a recognition result of an action that is based on various types of sensor data detected by the sensor 107 or an IoT sensor of an external device that is linkable with the information processing terminal 1, for example. As an observation context of action, for example, information indicating “cooking”, “eating”, “watching a television”, or “staying with xx” is described.

In this manner, as accompanying information of episodic memory, an observation context at the time of operation that is considered to be memorized by the user is recorded in the user operation log.

Note that an observation context of feeling, mood, action, or the like can be said to be memorable meta-information with a high abstraction degree. Such an observation context may be recorded in the user operation log in association with a function sequence as described with reference to FIG. 10, or may be recorded in a state monitoring log being data different from the user operation log.

A state indicating an observation context at the time of each operation is recorded in the state monitoring log together with a time stamp of a change point of an observation context in such a manner that a context at each timing can be checked on the basis of a time stamp of the user operation log.

Furthermore, a generation context at the time of operation that is considered to be memorized by the user as accompanying information of episodic memory is appropriately recorded in the user operation log. The generation context indicates an event generated by the information processing system side to be experience by the user.

The context generation unit 272 in FIG. 9 generates a generation context for recording an operation in the user operation log, in accordance with an operation for executing a predetermined function being performed, and causes the user to experience the generation context as an event by presenting the generation context to the user.

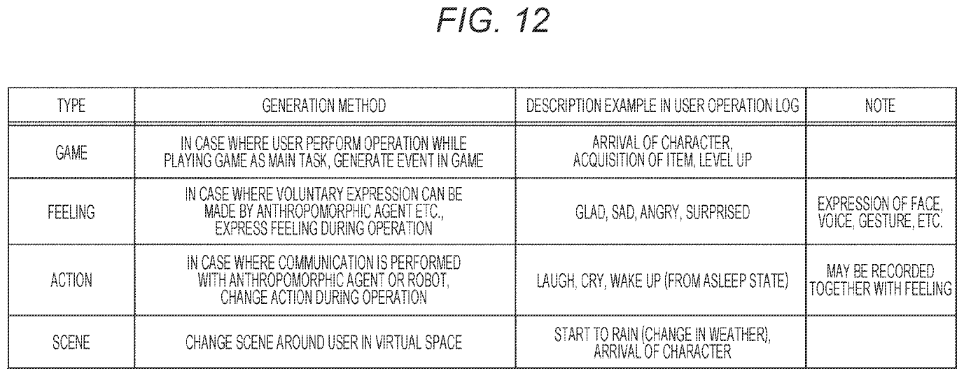

FIG. 12 is a diagram illustrating an example of a generation context.

As illustrated on the left column in FIG. 12, the type of the generation context includes game, feeling, action, and scene.

A generation context of game indicates an event experienced within a game being played by the user as a main task.

A generation context of game is generated by generating an event such as, for example, arrival of a character, acquisition of an item, and level up within the game. The context generation unit 272 instructs the task management server 4 to generate such an event within the game being played by the user, and causes the user to experience the event.

Information indicating the generation of an event such as “arrival of character”, “acquisition of item”, and “level up” is described in the user operation log as a generation context of game.

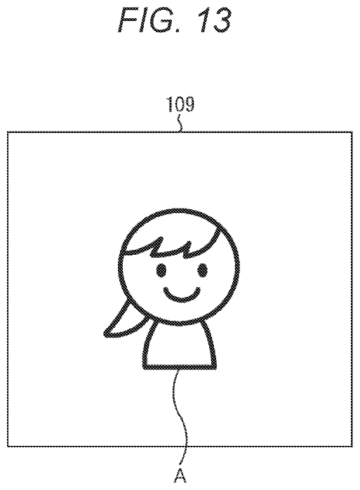

A generation context of feeling indicates feeling of an agent communicating with the user. For example, in a case where the user is performing an operation of speaking to an anthropomorphic agent A (character) displayed on the display 109 of the information processing terminal 1 as illustrated in FIG. 13, a generation context of feeling is generated. The display of the agent A is controlled by the display image processing unit 261, for example.

A generation context of feeling is generated by changing the feeling of the agent A. The context generation unit 272 changes the expression of the agent A by controlling the response control unit 274 or the like, for example, and causes the user to recognize the feeling of the agent A.

Information indicating the feeling of the agent A such as “glad”, “sad”, “angry”, or “surprised” is described in the user operation log as a generation context of feeling.

A generation context of action indicates an action of an agent or a robot communicating with the user. For example, in a case where the user is performing an operation of speaking to the agent A, a generation context of action is generated. In a case where the user is performing an operation of speaking to a robot controllable from the information processing server 2, a generation context of action may be generated.

A generation context of action is generated by changing an action of an agent or a robot communicating with the user. The context generation unit 272 controls an action of an agent or a robot by controlling the response control unit 274 or the like, and causes the user to recognize the action of the agent or the robot.

Information indicating an action of an agent or a robot such as “laugh”, “cry”, or “wake up” is described in the user operation log as a generation context of action.

A generation context of scene indicates a scene recognized by the user on a virtual space.

A generation context of scene is generated by changing a scene on a virtual space, for example. The context generation unit 272 instructs the task management server 4 to change a scene on a virtual space, and causes the user to experience the change in the scene.

Information indicating a change in scene such as “start to rain” or “arrival of character” is described in the user operation log as a generation context of scene.

In this manner, in the information processing server 2, processing of generating an event considered to be memorized by the user as accompanying information of episodic memory, and causing the user to experience the event, and recording information regarding the event, in the user operation log as a generation context is performed.

In a case where a game, an action on a virtual space, or the like is performed as a main task at the time of a voice operation, because the user is conscious of the main task, it becomes difficult to remember an operation performed at the time. By generating an event of a game or the like from the information processing system side, and causing the user to experience the event, it becomes possible to cause the user to memorize content of the event as accompanying information of episodic memory.

In a case where the user performs the same operation as a past operation, the user can think of the past operation from an event or the like generated in the game that has been performed as a main task.

Note that the generation of a generation context may be performed for preventing contexts of the respective function sequences (contexts recorded in association) from overlapping.

Specifically, in a case where an observation context observed at the time of a certain operation does not overlap an observation context of a function sequence related to a similar operation, the generation of a generation context is not performed.

In contrast, in a case where an observation context observed at the time of a certain operation overlaps an observation context of a function sequence related to a similar operation, the generation of a generation context is performed. Also in a case where an observation context of types other than time and date and location cannot be observed, a generation context is similarly generated.

In a case where a generation context is generated as a context at the time of a certain operation, a generation context of a type not recorded in association with a function sequence related to a similar operation, or a generation context of a type with little overlap may be generated.

In this manner, generation of a generation context is performed in such a manner that contexts of the user operation log do not overlap, or in such a manner that an overlap of contexts becomes small. By generating a generation context in such a manner that contexts of the respective function sequences do not overlap, the function sequences correspond to the respective contexts on a one-to-one basis. The user can easily issue an execution instruction of a function sequence using an instruction word Entity.

The description will return to the description of FIG. 9. The context generation unit 272 generates various generation contexts by controlling the response control unit 274 or the like, and causes the user to experience an event. Furthermore, the context generation unit 272 outputs information regarding the generation contexts to the user operation log record control unit 271, and causes the user operation log record control unit 271 to record the generation contexts in the user operation log.

Search and Execution of Function Sequence

In a case where a function sequence suitable for user utterance is searched for, the macro extraction unit 273 selects, from among macro extraction templates stored in the macro extraction template DB 257, a macro extraction template for Intent that is estimated by the utterance intent comprehension processing unit 252.

A macro extraction template is a template defining a sequence including a plurality of functions that is desired to be collectively executed as a macro. A plurality of macro extraction templates is predefined for each function to be converted into a macro, and is prepared in the macro extraction template DB 257.

A function sequence matching a function sequence defined in a macro extraction template is retrieved from among function sequences recorded in the user operation log, and is extracted as a macro. In this manner, a macro extraction template is information used for searching of a function sequence.

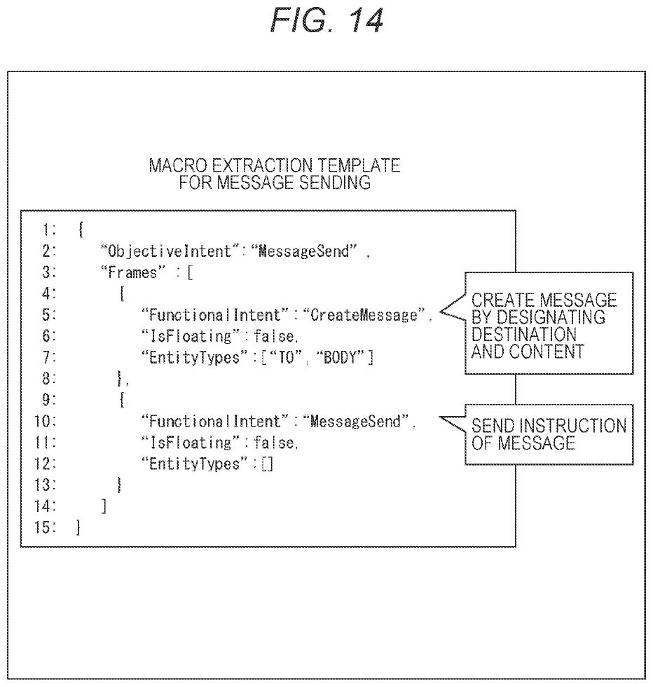

FIGS. 14 to 16 are diagrams each illustrating an example of a macro extraction template.

As illustrated in FIG. 14, ObjectiveIntent and Frames are described in a macro extraction template. FunctionalIntent, IsFloating, and EntityTypes, which serve as information regarding each function included in a function sequence, are described as Frames.

ObjectiveIntent indicates objective Intent of the macro extraction template. A macro extraction template having objective Intent matching Intent estimated from user utterance including instruction word Entity is selected.

Frames indicate a function sequence to be converted into a macro.

FunctionalIntent indicates Intent of a function included in a function sequence to be converted into a macro.

IsFloating is a flag indicating whether or not each function is essential as a function included in a function sequence.

A function having IsFloating set to “False” is an element essential as a function included in a function sequence. A function sequence in which the same functions as the function having IsFloating set to “False” are recorded in an order described in a macro extraction template is searched for.

On the other hand, a function having IsFloating set to “True” is an optional element as a function included in a function sequence. In a case where the same function as the function having IsFloating set to “True” exists within the same cluster as the function having IsFloating set to “False”, the functions are incorporated into a macro.

EntityTypes indicates an Entity type. A function sequence in which Entities of all Entity types defined in EntityTypes are recorded as Entity corresponding to Intent is searched for.

The macro extraction template in FIG. 14 is a macro extraction template for message sending.

As illustrated on the second row in FIG. 14, ObjectiveIntent of the macro extraction template for message sending is “MessageSend” indicating a sending function of a message. In a case where Intent of utterance including instruction word Entity is “MessageSend”, the macro extraction template for message sending is selected.

As illustrated on the fifth to seventh rows, in Frames of the macro extraction template for message sending, as information regarding the first function included in a function sequence, FunctionalIntent=“CreateMessage”, IsFloating=“false”, and EntityTypes=“[“TO”, “BODY” ]” are described. Furthermore, as illustrated on the 10th to 12th rows, as information regarding the second function included in the function sequence, FunctionalIntent=“MessageSend”, IsFloating=“false”, and EntityTypes=“[ ]” are described.

On the basis of the macro extraction template including such descriptions, a function sequence in which Intent of “CreateMessage” including Entity with Entity types of “TO” and “BODY” is recorded, and Intent of “MessageSend” is subsequently recorded is searched for. Intent of “CreateMessage” indicates message creation, and Intent of “MessageSend” indicates a message send instruction.

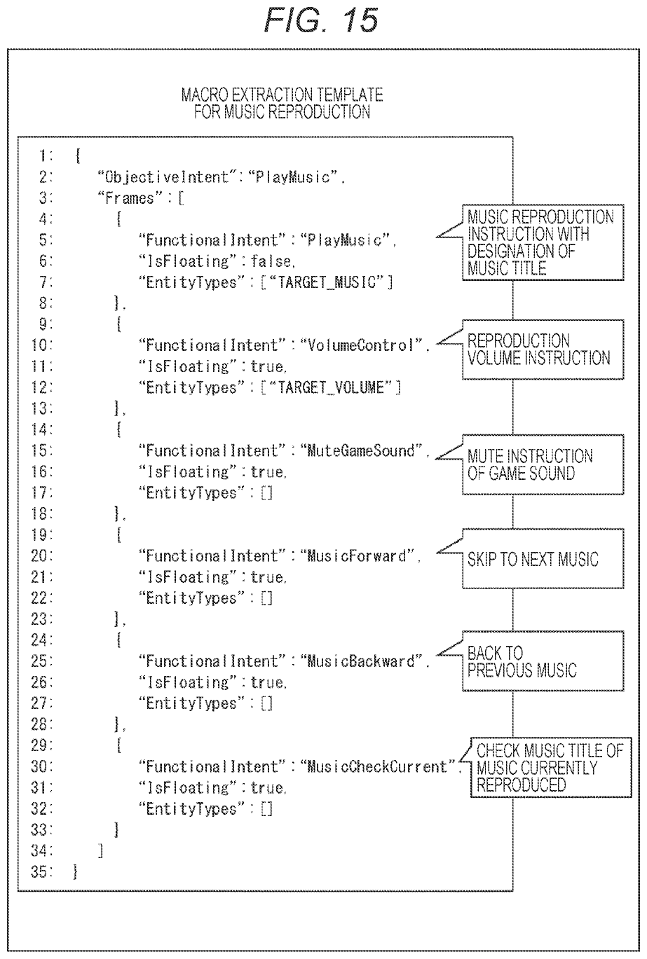

A macro extraction template in FIG. 15 is a macro extraction template for music reproduction.

As illustrated on the second row in FIG. 15, ObjectiveIntent of the macro extraction template for music reproduction is “PlayMusic” indicating a reproduction function of music. In a case where Intent of utterance including instruction word Entity is “PlayMusic”, the macro extraction template for music reproduction is selected.

Also in Frames of the macro extraction template for music reproduction, information regarding each function included in a function sequence is sequentially described. On the basis of the macro extraction template including descriptions in FIG. 15, a function sequence in which Intent of “PlayMusic” including Entity of Entity type of “TARGET_MUSIC” is recorded is searched for. Intent of “PlayMusic” indicates a music reproduction instruction.

In a case where Intents of “VolumeControl”, “MuteGameSound”, “MusicForward”, “MusicBackward”, and “MusicCheckCurrent” are described in the retrieved function sequence, the functions are also incorporated into a macro and executed.

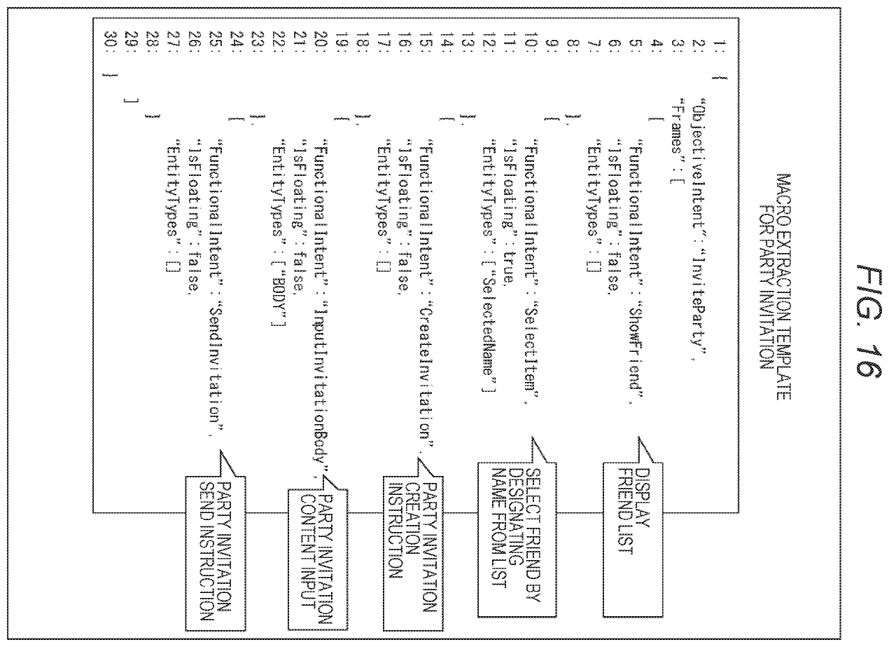

FIG. 16 is a diagram illustrating an example of a macro extraction template for party invitation. A party is a group of users who play a game together within an online game, for example.

As illustrated on the second row in FIG. 16, ObjectiveIntent of the macro extraction template for party invitation is “InviteParty” indicating a sending function of a guide for inviting to a party. In a case where Intent of utterance including instruction word Entity is “InviteParty”, the macro extraction template for party invitation is selected.

Also in Frames of the macro extraction template for party invitation, information regarding each function included in a function sequence is sequentially described. On the basis of the macro extraction template including the descriptions in FIG. 16, a function sequence in which Intent of “ShowFriends”, Intent of “CreateInvitation”, Intent of “InputInvitationBody”, and Intent of “SendInvitation” are sequentially described is searched for.

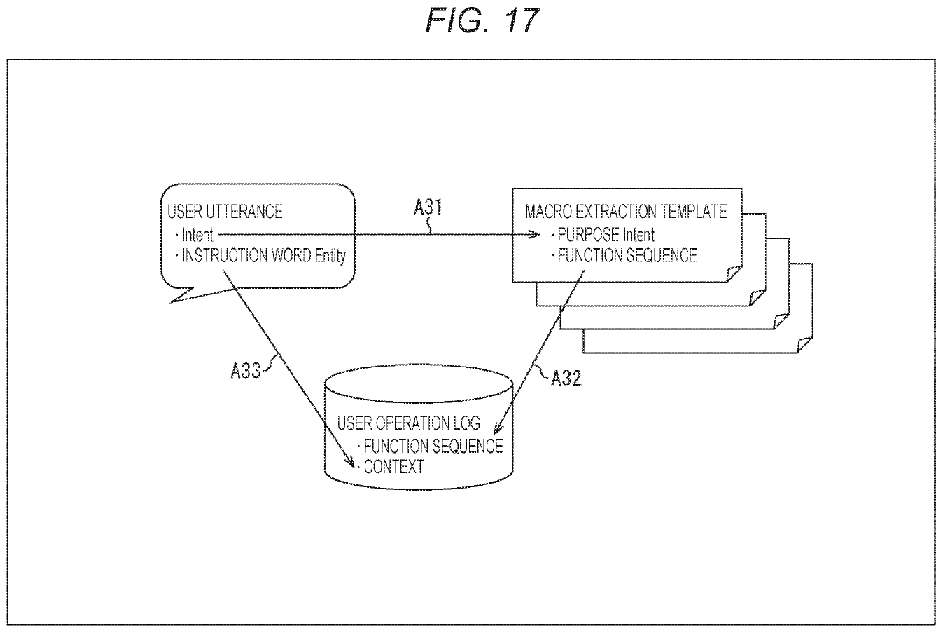

FIG. 17 is a diagram illustrating a search example of a function sequence that uses a macro extraction template.

As indicated by an arrow A31, the macro extraction unit 273 selects a macro extraction template including objective Intent matching Intent of utterance, from among macro extraction templates stored in the macro extraction template DB 257.

Furthermore, as indicated by an arrow A32, the macro extraction unit 273 searches function sequences recorded in the user operation log, for a function sequence matching a function sequence defined in the selected macro extraction template. In the retrieved function sequence, a context is recorded in association.

As indicated by an arrow A33, the macro extraction unit 273 searches function sequences serving as a search result that are based on a macro extraction template, for a function sequence recorded in association with a context indicated by instruction word Entity included in an utterance text. The macro extraction unit 273 extracts a plurality of functions included in the retrieved function sequence, as a macro. In this manner, the macro extraction unit 273 functions as a search unit that searches for a function sequence recorded in association with a context indicated by instruction word Entity.

In a case where the number of macros extracted as a search result is one, the macro extraction unit 273 instructs the response control unit 274 to execute the macro. Furthermore, in a case where a plurality of macros is extracted as a search result, the macro extraction unit 273 presents information regarding each macro to the user, and instructs the response control unit 274 to execute a selected macro.

The response control unit 274 controls the response generation unit 259 to execute a function indicated by Intent/Entity supplied from the utterance intent comprehension processing unit 252.

Furthermore, in a case where information regarding one macro is supplied from the macro extraction unit 273, the response control unit 274 controls the response generation unit 259 to collectively execute a plurality of functions included in a function sequence, as a macro.

In a case where information regarding a plurality of macros is supplied from the macro extraction unit 273 as a search result, the response control unit 274 controls the response generation unit 259 to present the macros to the user. The response control unit 274 executes a macro selected by the user from among the presented macros.

Specific Example of Search of Function Sequence

A specific example of search of a function sequence will be described.

Here, it is assumed that utterance “send a message of yester” is performed by the user on 8, June. In this case, by NLU processing performed by the utterance intent comprehension processing unit 252, Intent of “MessageSend” is estimated, and instruction word Entity of “yesterday” is extracted.

In the macro extraction unit 273 of the operation record search processing unit 256, from among macro extraction templates stored in the macro extraction template DB 257, the macro extraction template for message sending in FIG. 14 in which objective Intent is “MessageSend” is selected.

As a function sequence matching a function sequence defined in the macro extraction template for message sending, the function sequence illustrated in FIG. 10 is retrieved from the user operation log.

The function sequence serving as a search result is function sequence including an item of Intent=“CreateMessage” and an item of Intent=“MessageSend”.

The item of Intent=“CreateMessage” includes Entity with Entity type=“TO” and Entity literal=“Sato”, Entity with Entity type=“TO” and Entity literal=“Suzuki”, and Entity with Entity type=“BODY” and Entity literal=“let us play from now”.

It is assumed that a function sequence other than the function sequence illustrated in FIG. 10 is retrieved on the basis of a function sequence defined in the macro extraction template for message sending.

The instruction word Entity “yesterday” included in the utterance performed on 8, June indicates 7, June, which is a previous day. In the macro extraction unit 273, from among a plurality of function sequences serving as a search result that is based on the macro extraction template, the function sequence in FIG. 10 in which a context indicating 7, June is recorded in association is selected as a final search result. In the function sequence in FIG. 10, a context of DateTime=“2018-06-07T11:14:28.867+09:00” indicating 7, June is recorded in association.

A function sequence including the item of Intent=“CreateMessage” and the item of Intent=“MessageSend” that is included in the function sequence in FIG. 10 is extracted as a macro, and supplied to the response generation unit 259 as the response control unit 274.

In accordance with control performed by the response control unit 274, the response generation unit 259 generates and sends a message “let us play from now” including “Sato” and “Suzuki” as send destinations.

In this manner, on the basis of accompanying information of episodic memory indicating that a message has been sent “yesterday”, the user can easily execute creation of a message “let us play from now” and sending of the message by indicating it using instruction word Entity.

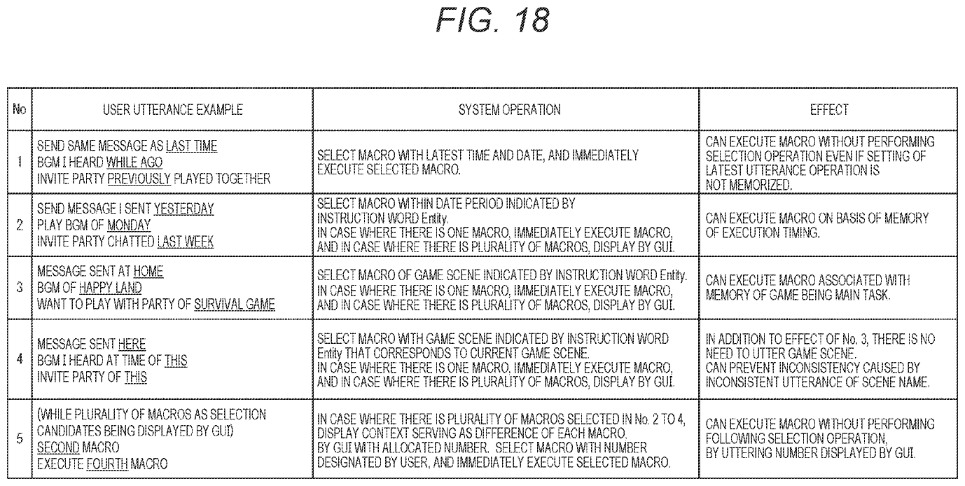

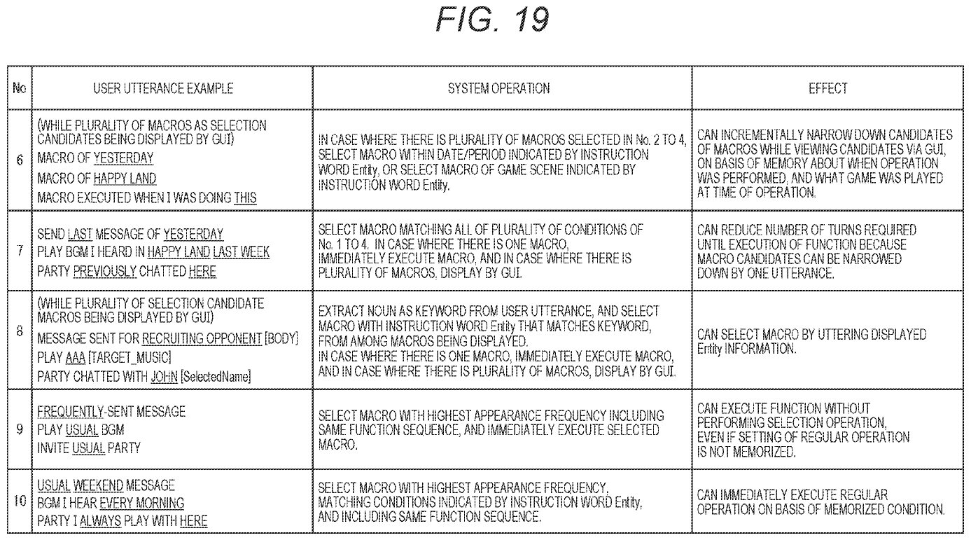

FIGS. 18 and 19 are diagrams each illustrating a search example that uses instruction word Entity.

In FIGS. 18 and 19, an operation of an information processing system (the information processing server 2) to be performed in a case where each utterance is performed is illustrated. Among utterances of the user illustrated on the second column from the left, an underlined character string is instruction word Entity.

Utterance of No. 1 is utterance including instruction word Entity indicating a certain timing.

In a case where the utterance of No. 1 is performed, a search of a function sequence is performed using a context of date (DateTime). More specifically, from among function sequences serving as a search result that are based on a macro extraction template, a function sequence in which the latest date is recorded as a context is extracted, and immediately executed as a macro. The immediate execution of a macro means that a function sequence serving as a search result is automatically executed as a macro without being selected by the user.

Utterance of No. 2 is utterance including instruction word Entity indicating date/period.

Also in a case where the utterance of No. 2 is performed, a search of a function sequence is performed using a context of date (DateTime). From among function sequences serving as a search result that are based on a macro extraction template, a function sequence in which a context indicating date/period indicated by instruction word Entity is recorded is searched for. In a case where there is one function sequence serving as a search result, the function sequence serving as a search result is immediately executed as a macro, and in a case where there is a plurality of function sequences, after each macro is presented to the user, a macro selected by the user is executed.

Utterance of No. 3 is utterance including instruction word Entity indicating a game scene.

In a case where the utterance of No. 3 is performed, a search of a function sequence is performed using a game scene context (GameScene) From among function sequences serving as a search result that are based on a macro extraction template, a function sequence in which a context indicating a game scene indicated by instruction word Entity is recorded is searched for. In a case where there is one function sequence serving as a search result, the function sequence serving as a search result is immediately executed as a macro, and in a case where there is a plurality of function sequences, after each macro is presented to the user, a macro selected by the user is executed.

The utterance of No. 3 is performed when the user is playing a game as a main task, for example. Examples of utterances performed in a case where search is performed using a game scene context include “message sent when I defeated XX”, “BGM I heard when XX finished”, “party played together before playing against XX”, “party played together at the time of this enemy” and the like, aside from the utterances illustrated in FIG. 18.

Utterance of No. 4 is utterance including a pronoun indicating a game scene as instruction word Entity.

In a case where the utterance of No. 4 is performed, a search of a function sequence is performed using a game scene context (GameScene) From among function sequences serving as a search result that are based on a macro extraction template, a function sequence in which a context indicating a game scene matching a current game scene indicated by instruction word Entity of the pronoun is recorded is searched for. In a case where there is one function sequence serving as a search result, the function sequence serving as a search result is immediately executed as a macro, and in a case where there is a plurality of function sequences, after each macro is presented to the user, a macro selected by the user is executed.

The utterance of No. 4 is performed by, for example, the user performing a game as a main task, and indicating, by a pronoun, a target highlighted by a cursor on a screen of the game. Examples of utterances performed in a case where search is performed using a game scene context include “message sent when I acquired this” in a state in which an item displayed on the screen of the game is highlighted, and the like, aside from the utterances illustrated in FIG. 18. Furthermore, examples include “party played together here” in a state in which a specific location is designated on a map displayed on the screen of the game, and the like.

Utterance of No. 5 is utterance including instruction word Entity indicating a number of a macro.

The utterance of No. 5 is performed in a case where a macro serving as a search result is presented. In accordance with the utterances of No. 2 to 4 being performed, from among function sequences serving as a search result that are based on a macro extraction template, a function sequence in which a context indicated by instruction word Entity is recorded in association is searched for.

In a case where there is a plurality of macros serving as a search result, a number is allocated to each macro, and the macros are presented to the user. On a presentation screen of a macro, among contexts of the respective function sequences, a context serving as a difference from (not overlapping) a context of another function sequence is displayed.

In a case where utterance including a number as instruction word Entity is performed, a function sequence to which the number designated by the instruction word Entity is allocated is executed as a macro. The details of the presentation screen of macros will be described later.

Utterance of No. 6 in FIG. 19 is utterance including instruction word Entity indicating a macro by date/period or a game scene.

The utterance of No. 6 is also performed in a case where a macro serving as a search result is presented. In accordance with the utterances of No. 2 to 4 being performed, from among function sequences serving as a search result that are based on a macro extraction template, a function sequence in which a context indicated by instruction word Entity is recorded in association is searched for.

In a case where there is a plurality of macros serving as a search result, a number is allocated to each macro, and the macros are presented to the user. On a presentation screen of a macro, among contexts of the respective function sequences, a context serving as a difference from a context of another function sequence is displayed.

In a case where utterance including instruction word Entity is performed, a function sequence in which a context indicating date/period designated by the instruction word Entity is recorded in association, or a function sequence in which a context indicating a game scene designated by the instruction word Entity is recorded in association is executed as a macro.

The utterance of No. 7 is utterance including a plurality of instruction words Entity.

In a case where the utterance of No. 7 is performed, from among function sequences serving as a search result that are based on a macro extraction template, a function sequence including a context indicated by AND condition of a plurality of instruction words Entity is searched for. In a case where there is one function sequence serving as a search result, the function sequence serving as a search result is immediately executed as a macro, and in a case where there is a plurality of function sequences, after each macro is presented to the user, a macro selected by the user is executed.

Utterance of No. 8 is utterance indicating a macro by a keyword.

The utterance of No. 8 is also performed in a case where a macro serving as a search result is presented. In accordance with the utterances of No. 2 to 4 being performed, from among function sequences serving as a search result that are based on a macro extraction template, a function sequence in which a context indicated by instruction word Entity is recorded in association is searched for.

In a case where there is a plurality of macros serving as a search result, a number is allocated to each macro, and the macros are presented to the user. On a presentation screen of a macro, among contexts of the respective function sequences, a context serving as a difference from a context of another cluster is displayed.

In a case where the utterance of No. 8 is performed, a character string of a noun is extracted from the utterance of the user as a keyword. A macro including the same character string as the extracted keyword as Entity is executed.

A macro may be designated by utterance that uses the number of Entities like “party including five players”.

Utterance of No. 9 is utterance including instruction word Entity indicating cycle/frequency.

In a case where the utterance of No. 9 is performed, a search of a function sequence is performed using a context of date (DateTime). From among function sequences serving as a search result that are based on a macro extraction template, a function sequence having the highest appearance frequency is selected and immediately executed as a macro.

Utterance of No. 10 is utterance including instruction word Entity indicating cycle/frequency.

In a case where the utterance of No. 10 is performed, a search of a function sequence is performed using a context of date (DateTime). From among function sequences serving as a search result that are based on a macro extraction template, a function sequence satisfying a condition designated by instruction word Entity, and having the highest appearance frequency is selected and immediately executed as a macro.

The search of a macro that uses instruction word Entity is performed in the above-described manner.

A search of a macro that is based on utterance that uses instruction word Entity indicating an observation context illustrated in FIG. 11 or a generation context illustrated in FIG. 12 in place of instruction word Entity illustrated in FIGS. 18 and 19 is performed.

For example, utterance of “music played when being glad” is utterance indicating an observation context (FIG. 11) of feeling by instruction word Entity. Furthermore, utterance of “music played when exciting” is utterance indicating an observation context of mood by instruction word Entity. Utterance of “music played when cooking” is utterance indicating an observation context of action by instruction word Entity.

Utterance of “surprising message” is utterance indicating a generation context (FIG. 12) of feeling by instruction word Entity. Utterance of “music when raining” is utterance indicating a generation context of scene by instruction word Entity.

### Operation of Information Processing System

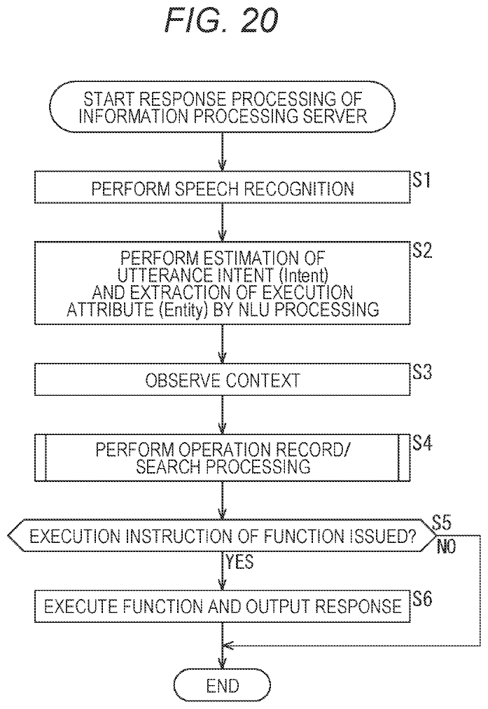

Processing of the information processing server 2 for making a response to user utterance will be described with reference to a flowchart in FIG. 20.

The processing in FIG. 20 is started when voice data corresponding to utterance of the user is transmitted from the information processing terminal 1, for example. The voice data transmitted from the information processing terminal 1 is received by the communication unit 209 and supplied to the speech recognition processing unit 251.

In Step S1, the speech recognition processing unit 251 performs speech recognition processing on user utterance, and converts the utterance into text data.

In Step S2, by performing NLU processing on the utterance text, the utterance intent comprehension processing unit 252 estimates Intent indicating the intent of utterance, and extracts Entity being an execution attribute.

In Step S3, observation of a context is performed. More specifically, observation of a context that is based on an image captured by the camera 106 is performed by the image recognition processing unit 254, and observation of a context that is based on sensor data detected by the sensor 107 is performed by the sensor data recognition processing unit 255. The observed context is output to the operation record search processing unit 256 as an observation context.

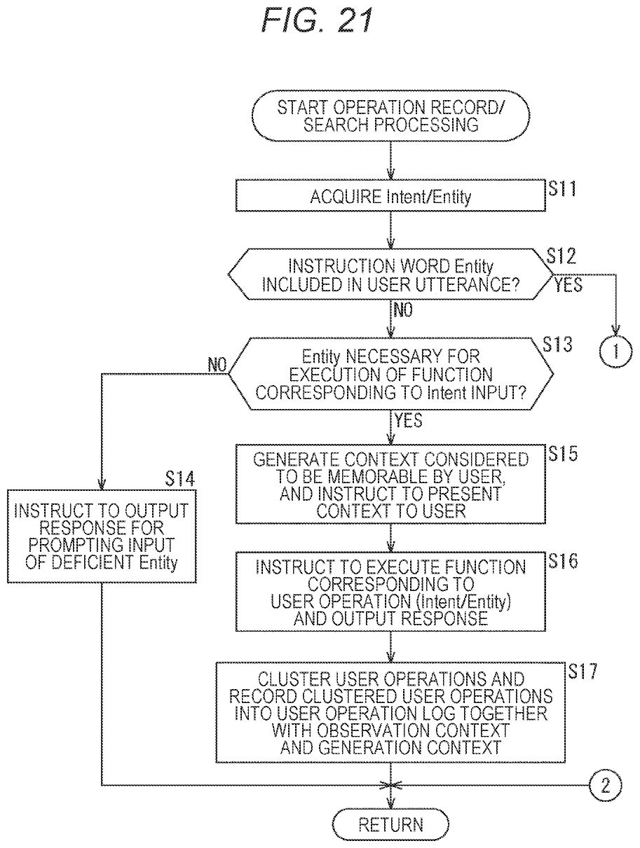

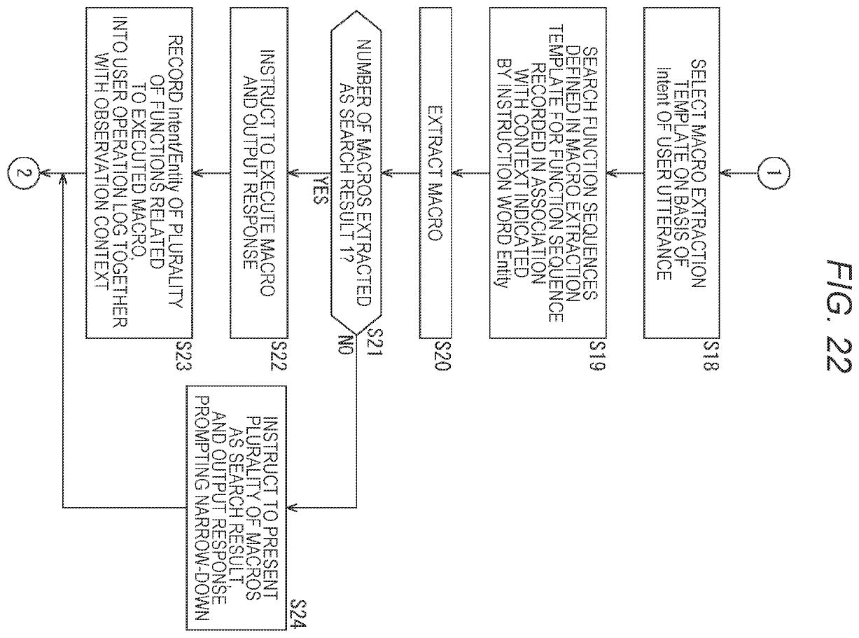

In Step S4, operation record/search processing is performed by the operation record search processing unit 256. By the operation record/search processing, a history of an operation of the user is managed, and a macro is appropriately executed on the basis of instruction word Entity included in utterance. The details of the operation record/search processing will be described later with reference the flowcharts in FIGS. 21 and 22.

In Step S5, the response generation unit 259 determines whether or not an execution instruction of a function has been issued by the operation record search processing unit 256.

In a case where it is determined in Step S5 that an execution instruction of a function has been issued, in Step S6, the response generation unit 259 executes one function in accordance with control performed by the operation record search processing unit 256, and outputs a response to the user. Furthermore, the response generation unit 259 collectively executes a plurality of functions as a macro in accordance with control performed by the operation record search processing unit 256, and outputs a response to the user.

In a case where a predetermined function is executed in Step S6, or in a case where it is determined in Step S5 that an execution instruction of a function has not been issued, the processing ends. The above processing is repeatedly performed each time the user performs utterance.

Next, the operation record/search processing performed in Step S4 of FIG. 20 will be described with reference to the flowcharts in FIGS. 21 and 22.

In Step S11, the operation record search processing unit 256 acquires Intent/Entity supplied from the utterance intent comprehension processing unit 252.

In Step S12, the operation record search processing unit 256 determines whether or not instruction word Entity is included in user utterance.

In a case where it is determined in Step S12 that instruction word Entity is not included in user utterance, in Step S13, the operation record search processing unit 256 determines whether or not Entity necessary for execution of a function corresponding to Intent has been input.

In a case where it is determined in Step S13 that Entity necessary for execution of a function corresponding to Intent has not been input, in Step S14, the response control unit 274 of the operation record search processing unit 256 instructs the response generation unit 259 to output a response prompting input of deficient Entity. In the response generation unit 259, processing of outputting synthesized voice prompting input of Entity, from the speaker 108, and the like are performed.

On the other hand, in a case where it is determined in Step S13 that Entity necessary for execution of a function corresponding to Intent has been input, the processing proceeds to Step S15.

In Step S15, the context generation unit 272 instructs the response control unit 274 to generate an event considered to be memorable by the user, as a generation context, and present the event to the user.

In accordance with the instruction issued by the context generation unit 272, the response control unit 274 requests the task management server 4 to generate a predetermined event within a game being played by the user as a main task, for example. In the task management server 4, processing of generating an event of a game in accordance with a request issued by the response control unit 274, and causing the user to experience the event is performed.

In Step S16, the response control unit 274 instructs the response generation unit 259 to execute a function corresponding to Intent/Entity supplied from the utterance intent comprehension processing unit 252, and output a response.

In Step S17, the user operation log record control unit 271 generates a function sequence including a plurality of functions, by clustering functions indicated by Intent/Entity supplied from the utterance intent comprehension processing unit 252.

Furthermore, the user operation log record control unit 271 records the function sequence into the user operation log in association with the observation context observed in Step S3 of FIG. 20, and the generation context generated by the context generation unit 272. Either one of the observation context and the generation context may be recorded in association with the function sequence instead of both being recorded.

After the function sequence is recorded in Step S17, or after an output instruction of the response prompting input of Entity has been issued in Step S14, the processing returns to Step S4 of FIG. 20, and processing in Step S4 and subsequent steps is performed.

Note that, when recording into the user operation log is performed, synthesized voice such as “present operation is memorized” may be output from the information processing system side, and the user may be caused to recognize that information regarding a series of operation has been recorded. The user can recognize that a series of operations can be executed as a macro.

Note that, as for a function including personal information such as content of a message, and including content that provides a feeling of strangeness to the user if being recorded in the user operation log, checking may be performed by outputting synthesized voice like “memorize content of sent message?”. In this case, when an approval for recording of information is obtained, recording into the user operation log is performed.

On the other hand, in a case where it is determined in Step S12 that instruction word Entity is included in user utterance, the processing proceeds to Step S18 of FIG. 22. in a case where instruction word Entity is included in user utterance, a search of a function sequence is performed as described above.

In Step S18, the macro extraction unit 273 of the operation record search processing unit 256 selects a macro extraction template including objective Intent matching Intent of the user utterance, from among macro extraction templates stored in the macro extraction template DB 257.

In Step S19, the macro extraction unit 273 searches function sequences recorded in the user operation log, for a function sequence matching a function sequence defined in the selected macro extraction template. Furthermore, the macro extraction unit 273 searches function sequences serving as a search result that are based on a macro extraction template, for a function sequence recorded in association with a context indicated by instruction word Entity included in an utterance text.

In Step S20, the macro extraction unit 273 extracts a plurality of functions included in the retrieved function sequence, as a macro.

In Step S21, the macro extraction unit 273 determines whether or not the number of macros extracted as a search result is one.

In a case where it is determined in Step S21 that the number of macros extracted as a search result is one, in Step S22, the macro extraction unit 273 instructs the response control unit 274 to execute the macro and output a response to the user.

In Step S23, the user operation log record control unit 271 records Intent/Entity of a plurality of functions related to an executed macro, into the user operation log together with an observation context.

In a case where it is determined in Step S21 that the number of macros extracted as a search result is not one, in Step S24, the macro extraction unit 273 presents a plurality of macros as a search result, and instructs the response control unit 274 to output response prompting narrow-down of macros.

After information regarding the executed macro is recorded into the user operation log in Step S23, or after a presentation instruction of a plurality of macros as a search result or the like has been issued in Step S24, the processing returns to Step S4 of FIG. 20, and processing in Step S4 and subsequent steps is performed.

By the above processing, by uttering a phrase associated with past memory, the user can collectively execute the same operations as a plurality of operations performed in the past, as a macro.

Furthermore, because a macro can be executed by indicating a context using instruction word Entity, a dialogue system closer to natural utterance as compared with a case where an execution instruction of a macro is issued by uttering a name or the like set to each macro is implemented.

### Example of Macro Presentation Screen

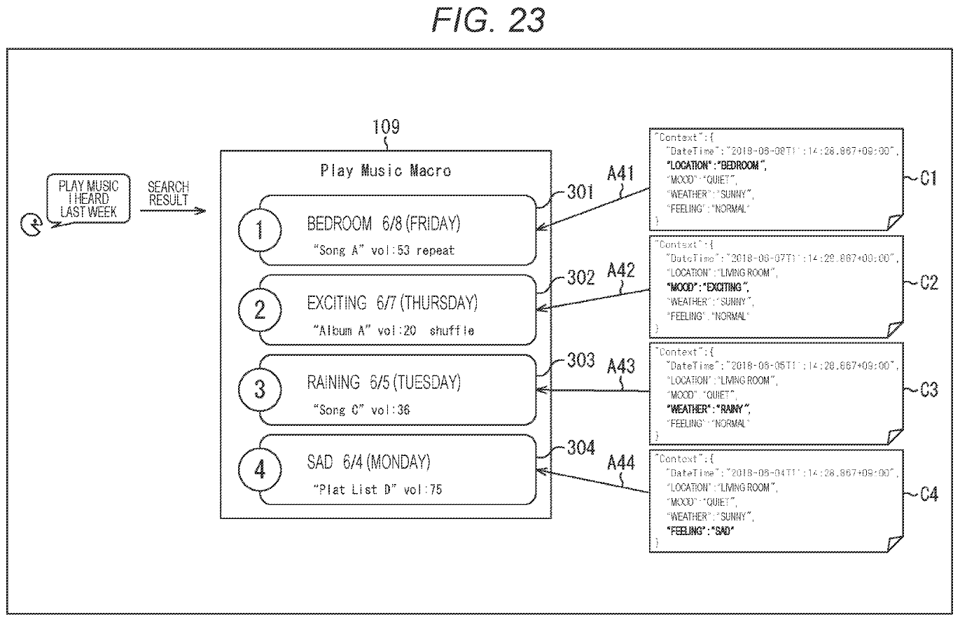

FIG. 23 is a diagram illustrating an example of a presentation screen of a macro.

In a case where there is a plurality of macros as a search result, a presentation screen as illustrated in FIG. 23 is displayed on the display 109.

In the example illustrated in FIG. 23, in accordance with utterance “play music I heard last week” being performed by the user, the above-described search is performed, and four music reproduction macros having objective Intent of “PlayMusic” are found. On the presentation screen, macro candidate information pieces 301 to 304 being information regarding the four music reproduction macros are displayed.

The macro candidate information 301 is information regarding the first music reproduction macro. Character strings “bedroom”, and “6/8 (Friday)” are displayed as the macro candidate information 301, and information regarding music to be reproduced when the first music reproduction macro is executed is displayed below the macro candidate information 301.

The character strings “bedroom”, and “6/8 (Friday)” are displayed on the basis of a context C1 being a context related to the first music reproduction macro, as indicated by an arrow A41. The context C1 includes a context of date indicating “8, June” and a context of a location indicating “bedroom”.

Note that the information regarding the music that is displayed below the character strings “bedroom”, and “6/8 (Friday)” is information displayed on the basis of Intent and Entity of the function included in the first music reproduction macro.

The macro candidate information 302 to 303 each include similar information as well.

More specifically, as the macro candidate information 302 being information regarding the second music reproduction macro, character strings “exciting” and “6/7 (Thursday)” are displayed.

The character strings “exciting” and “6/7 (Thursday)” are displayed on the basis of a context C2 being a context related to the second music reproduction macro, as indicated by an arrow A42. The context C2 includes a context of date indicating “7, June” and a context of a mood indicating “exciting”.

As the macro candidate information 303 being information regarding the third music reproduction macro, character strings “raining” and “6/5 (Tuesday)” are displayed.

The character strings “raining” and “6/5 (Tuesday)” are displayed on the basis of a context C3 being a context related to the third music reproduction macro, as indicated by an arrow A43. The context C3 includes a context of date indicating “5, June” and a context of a weather indicating “raining”.

As the macro candidate information 304 being information regarding the fourth music reproduction macro, character strings “sad” and “6/4 (Monday)” are displayed.

The character strings “sad” and “6/4 (Monday)” are displayed on the basis of a context C4 being a context related to the fourth music reproduction macro, as indicated by an arrow A44. The context C4 includes a context of date indicating “4, June” and a context of feeling indicating “sad”.

In this manner, on the presentation screen of a search result of macros, in addition to information indicating Intent and Entity of a function included in each macro, a character string serving as a difference element of a context is displayed. The character strings “bedroom”, and “6/8 (Friday)” of the macro candidate information 301, the character strings “exciting” and “6/7 (Thursday)” of the macro candidate information 302, the character strings “raining” and “6/5 (Tuesday)” of the macro candidate information 303, and the character strings “sad” and “6/4 (Monday)” of the macro candidate information 304 are character strings displayed on the basis of the contexts not overlapping the contexts of other macros.

On the other hand, “living room” overlapping as a context of location is not displayed as information regarding a macro. The context indicating “living room” is recorded in the contexts C2, C3, and C4 in an overlapping manner.

In this manner, in a case where there is a plurality of macros of a similar function sequence as a macro considered to be designated by the user by utterance including instruction word Entity, information regarding each macro is presented. Furthermore, as information regarding each macro, a character string serving as a difference element of a context is displayed.

Because the user can compare similar macros, and narrow down the macros on the basis of past fragmentary memory, an intended macro can be easily found.

Note that, in a case where a macro is selected by designating a number in a state in which the presentation screen illustrated in FIG. 23 is displayed, processing similar to processing performed when the utterance of No. 5 in FIG. 18 is performed is performed, and a selected macro is executed. Furthermore, in a case where a macro is selected by designating a character string serving as a different element of a context, processing similar to processing performed when the utterance of No. 6 in FIG. 19 is performed is performed, and a selected macro is executed

On the presentation screen of macros, information regarding a macro with a newer date of a context is presented at the top.

A presentation order may be switched on the basis of a context of a type other than a context of date. For example, the presentation order can be switched on the basis of a context of feeling. In this case, a macro with a positive context such as glad and fun is presented at the top.

In addition to the presentation via a GUI that uses a presentation screen, synthesized voice such as “Different contexts exits. Which do you choose?” may be output and the user may be asked.

### Modified Example

### Macro Conversion Method that does not Use Macro Extraction Template

A macro is generated from a plurality of functions included in a function sequence defined in a macro extraction template, but a macro may be generated in such a manner as to include a function not included in a function sequence defined in a macro extraction template.

Example of Presenting Function with High Appearance Frequency

It is assumed that a function sequence is selected, and a macro is generated. In this case, when there is a function with high appearance frequency in a cluster including the selected function sequence, presentation as to whether or not to execute the function is performed to the user.

For example, it is assumed that the user performs utterance “party invitation of HappyLand”, and a macro for party invitation at the time of playing HappyLand is generated in accordance with the utterance. “HappyLand” is a name of a game. A function sequence from which the macro for party invitation is generated does not include a delivery function of party invitation.

In this case, synthesized voice “deliver?” is output, and presentation as to whether or not to execute the delivery function of party invitation is performed. The presentation is performed on the basis of that the user frequently performs the function of party invitation and the delivery function at the time of playing HappyLand, for example.

By the user uttering “do delivery as well”, the delivery function is also executed together with the function of party invitation.

Note that in a case where the number of executions of the presented same function exceeds a predetermined number (e.g., twice), the function may be included in a macro without presentation and may be automatically executed.

Example of Executing all Functions in Cluster Only by Designating Context

For example, in a case where the user utters “collectively execute settings required when this game is started”, all functions such as party invitation, BGM reproduction, and delivery that are recorded in a cluster on the user operation log that is related to operations at the time of start of the game may be executed as a macro.

In a case where the user utters “prepare for sleeping”, “good night”, and the like, all functions such as turning off a light, shutting a television off, and setting an alarm that are recorded in a cluster on the user operation log that is related to an operation in bedtime may be executed as a macro.

The user can thereby collectively execute regular operations specific to itself.

### Other Examples

Configuration of Information Processing System

Processing of executing a macro suitable for an operation of the user is implemented by the information processing terminal 1 and the information processing server 2, but may be implemented by the information processing terminal 1 only. In this case, the configurations of the information processing server 2 illustrated in FIG. 7 are provided in the information processing terminal 1.

Not all configurations of the information processing server 2 illustrated in FIG. 7 need not be provided in the information processing terminal 1, and a part of the configurations may be provided in the information processing terminal 1, and other configurations may be provided in another apparatus such as the information processing server 2.

Example of Record Content of User Operation Log

A function sequence including a plurality of functions is recorded in association with a context, but information regarding one function may be recorded in a user operation log in association with a context obtained when an operation for executing the function is performed.

Variation of Observation Context

The following context may be observed and recorded as an observation context.
Clear up of specific scene in game (successful experience)
Game over/mission failure in game (failure experience)
What is being eaten during a meal.
In a case where the user performs u utterance “memorize music when I am sleepy”, “sleepy” is recorded as an observation context.
In a case where the user performs u utterance “memorize music when I did this” together with a predetermined gesture such as nodding, the gesture is recorded as an observation context. In this case, in a case where utterance “music played when I did this” is performed while performing the gesture, music recorded in association with an observation context indicating the gesture is reproduced.

Variation of Generation Context

The following context may be generated and recorded as a generation context.
Music or effect sound is output.
Smell is generated. In this case, the user memorizes content perceived by olfactory sense, such as “smell of XX” as accompanying information of episodic memory.
Vibration is generated, pain is generated, or temperature is changed in a device such as a controller that is touched by the user. In this case, the user memorizes content perceived by tactile sense, as accompanying information.
Speaker voice quality (male/female, adult/child, and the like) of synthesized voice used for a system response
Feedback

In recording content of a function in a user operation log, a context with which the function is recorded in association may be presented to the user. For example, a text indicating the content of a context may be displayed on a screen, or synthesized voice “memorize as music during eating” may be output.

In a case where instruction word Entity uttered by the user is managed in the information processing system as a target indicating context to be used for the search of a macro, at the time of execution of a macro using instruction word Entity, this may be presented to the user by outputting effect sound.

Security

A user operation log may be managed for each individual user. In a case where utterance including instruction word Entity is performed, when another person exists around the user who has performed the utterance, the execution of a function related to privacy such as the content of a message is restricted, and content may be prevented from being presented.

Presentation of Recommended Macro

Statistics of contexts recorded in a user operation log are collected for each attribute of the user such as gender, age, and area, and a recommended macro suitable for a context may be presented to the user on the basis of the statistics.

### Configuration Example of Computer

The above-described series of processes can be executed by hardware, and can be executed by software. In a case where the series of processes are executed by software, programs constituting the software are installed from a program recording medium onto a computer incorporated into dedicated hardware, or a general-purpose personal computer, or the like.

A program to be installed is provided with being recorded on the removable medium 211 illustrated in FIG. 6, including an optical disc (compact disc-read only memory (CD-ROM), digital versatile disc (DVD), etc.), a semiconductor memory, and the like. Furthermore, the programs may be provided via a wired or wireless transmission medium such as a local area network, the Internet, and digital broadcasting. The program can be preinstalled on the ROM 202 and the storage unit 208.

Programs executed by the computer may be programs according to which processes are chronologically performed in the order described in this specification. Alternatively, the programs may be programs according to which processes are performed in parallel, or at necessary timings such as a timing when call-out is performed.

Note that, in this specification, a system means a set of a plurality of constituent elements (apparatuses, modules (parts), and the like), and it does not matter whether or not all the constituent elements are provided in the same casing. Thus, a plurality of apparatuses stored in separate casings and connected via a network, and a single apparatus in which a plurality of modules is stored in a single casing are both regarded as systems.

Effects described in this specification are mere exemplifications and are not limited, and other effects may be caused.

An embodiment of the present technology is not limited to the above-described embodiment, and various changes can be made without departing from the scope of the present technology.

For example, the present technology can employ a configuration of cloud computing in which a single function is shared by a plurality of apparatuses and processed in cooperation with each other, via a network.

Furthermore, instead of being executed in a single apparatus, each step described in the above-described flowcharts can be executed by a plurality of apparatuses in a shared manner.

Moreover, in a case where a plurality of processes is included in a single step, the plurality of processes included in the single step can be executed by a plurality of apparatuses in a shared manner, instead of being executed in a single apparatus.

### Combination Example of Configurations

The present technology can also employ the following configurations.

(1) An information processing apparatus comprising:

a search unit configured to, on the basis of an operation log in which a function executed in accordance with an operation performed by a user, and a context obtained when the operation is performed are recorded in association, search for the function recorded in association with the context indicating an instruction word input by the user; and

a response control unit configured to execute the retrieved function and output a response to the user.

(2) The information processing apparatus according to (1) described above, further comprising a record control unit configured to generate a sequence including a plurality of the functions by clustering the functions executed in accordance with the operation performed by the user, and record the sequence and the context into the operation log in association.

(3) The information processing apparatus according to (1) or (2) described above, further comprising a recognition processing unit configured to recognize the context including a situation of the user.

(4) The information processing apparatus according to (3) described above, in which the recognition processing unit recognizes, as a situation of the user, at least any of time and date, a location, a task being performed by the user, feeling of the user, mood of a surrounding environment of the user, or an action of the user.

(5) The information processing apparatus according to any of (1) to (4) described above, further comprising a context generation unit configured to generate the context by executing processing for causing the user to experience a predetermined event.

(6) The information processing apparatus according to (5) described above, in which the context generation unit generates the context in accordance with the operation being performed.

(7) The information processing apparatus according to (5) or (6) described above, in which the context generation unit performs processing for generating an event on a task being performed by the user, and records information regarding the event, as the context.

(8) The information processing apparatus according to (5) or (6) described above, in which the context generation unit performs processing for changing an action of a target with which the user is communicating, and records information regarding the action, as the context.

(9) The information processing apparatus according to (2) described above, in which the search unit searches for the sequence that is same as the sequence defined in the template suitable for an intent of an input performed by the user, among a plurality of templates defining the sequence, and is recorded in association with the context indicated by the instruction word.

(10) The information processing apparatus according to (9) described above,

in which, in a case where there is a plurality of the sequences as a search result, the search unit presents information regarding each of the sequences, and

the response control unit executes a plurality of the functions included in the sequence designated by the user.

(11) The information processing apparatus according to (10) described above, in which the search unit presents information indicating a different of each of the contexts, as information regarding the sequence.

(12) The information processing apparatus according to any of (2) and (9) to (11) described above, in which the response control unit executes a plurality of the functions included in the sequence recorded in association with the context.

(13) The information processing apparatus according to any of (1) to (12) described above, in which the operation by the user is performed by voice.

(14) An information processing method executed by an information processing apparatus, the information processing method comprising:

on the basis of an operation log in which a function executed in accordance with an operation performed by a user, and a context obtained when the operation is performed are recorded in association, searching for the function recorded in association with the context indicating an instruction word input by the user; and

executing the retrieved function and outputting a response to the user.

(15) A program for causing a computer to execute processing of:

on the basis of an operation log in which a function executed in accordance with an operation performed by a user, and a context obtained when the operation is performed are recorded in association, searching for the function recorded in association with the context indicating an instruction word input by the user; and

executing the retrieved function and outputting a response to the user.

### REFERENCE SIGNS LIST

1 Information processing terminal
2 Information processing server
251 Speech recognition processing unit
252 Utterance intent comprehension processing unit
253 Instruction word Entity DB
254 Image recognition processing unit
255 Sensor data recognition processing unit
256 Operation record search processing unit
257 Macro extraction template DB
258 User operation log DB
259 Response generation unit
260 Speech synthesis processing unit
261 Display image processing unit
271 User operation log record control unit
272 Context generation unit
273 Macro extraction unit
274 Response control unit

1. An information processing apparatus comprising:
a search unit configured to, on a basis of an operation log in which a function executed in accordance with an operation performed by a user, and a context obtained when the operation is performed are recorded in association, search for the function recorded in association with the context indicating an instruction word input by the user; and
a response control unit configured to execute the retrieved function and output a response to the user.

2. The information processing apparatus according to claim 1, further comprising a record control unit configured to generate a sequence including a plurality of the functions by clustering the functions executed in accordance with the operation performed by the user, and record the sequence and the context into the operation log in association.

3. The information processing apparatus according to claim 1, further comprising a recognition processing unit configured to recognize the context including a situation of the user.

4. The information processing apparatus according to claim 3, wherein the recognition processing unit recognizes, as a situation of the user, at least any of time and date, a location, a task being performed by the user, feeling of the user, mood of a surrounding environment of the user, or an action of the user.

5. The information processing apparatus according to claim 1, further comprising a context generation unit configured to generate the context by executing processing for causing the user to experience a predetermined event.

6. The information processing apparatus according to claim 5, wherein the context generation unit generates the context in accordance with the operation being performed.

7. The information processing apparatus according to claim 5, wherein the context generation unit performs processing for generating an event on a task being performed by the user, and records information regarding the event, as the context.

8. The information processing apparatus according to claim 5, wherein the context generation unit performs processing for changing an action of a target with which the user is communicating, and records information regarding the action, as the context.

9. The information processing apparatus according to claim 2, wherein the search unit searches for the sequence that is same as the sequence defined in the template suitable for an intent of an input performed by the user, among a plurality of templates defining the sequence, and is recorded in association with the context indicated by the instruction word.

10. The information processing apparatus according to claim 9,
wherein, in a case where there is a plurality of the sequences as a search result, the search unit presents information regarding each of the sequences, and
the response control unit executes a plurality of the functions included in the sequence designated by the user.

11. The information processing apparatus according to claim 10, wherein the search unit presents information indicating a different of each of the contexts, as information regarding the sequence.

12. The information processing apparatus according to claim 2, wherein the response control unit executes a plurality of the functions included in the sequence recorded in association with the context.

13. The information processing apparatus according to claim 1, wherein the operation by the user is performed by voice.

14. An information processing method executed by an information processing apparatus, the information processing method comprising:
on a basis of an operation log in which a function executed in accordance with an operation performed by a user, and a context obtained when the operation is performed are recorded in association, searching for the function recorded in association with the context indicating an instruction word input by the user; and
executing the retrieved function and outputting a response to the user.

15. A program for causing a computer to execute processing of:
on a basis of an operation log in which a function executed in accordance with an operation performed by a user, and a context obtained when the operation is performed are recorded in association, searching for the function recorded in association with the context indicating an instruction word input by the user; and
executing the retrieved function and outputting a response to the user.
